(19) United States
(12) Patent Application Publication
(10) Pub. No.: US 2024/0152016 A1
(43) Pub. Date: May 9, 2024

(54) SMART GLASS WITH WIRELESS POWER SOURCES

(71) Applicant: SAGE Electrochromics, Inc., Faribault, MN (US)

(72) Inventors: Bryan D. Greer, Northfield, MN (US); David Ryan Buszmann, New Market, MN (US)

(73) Assignee: SAGE Electrochromics, Inc., Faribault, MN (US)

(21) Appl. No.: 18/492,580

(22) Filed: Oct. 23, 2023

Related U.S. Application Data
(60) Provisional application No. 63/382,279, filed on Nov. 3, 2022.

(51) Int. Cl. G02F 1/153; E06B 9/24; H02J 7/35; H02J 50/40

(52) U.S. Cl. CPC G02F 1/153; E06B 9/24; H02J 7/35; H02J 50/40; H02S 20/22

(57) ABSTRACT

A smart glass system for mounting on a glass frame includes a smart glass frame, a smart glass retained by the smart glass frame, one or more mounting devices attached to the smart glass frame for glass frame mounting, and a plurality of power receiving devices in electronic communication with the smart glass for receiving wireless power for the smart glass. The plurality of power receiving devices include one or more solar panels and one or more wireless power receivers. The smart glass system also includes one or more power storage devices for storing power from the one or more power receiving devices. The smart glass system further includes a controller for managing power flow between the plurality of power receiving devices, the one or more power storage devices, and the smart glass.

### PRIORITY CLAIM

This application claims benefit of priority to U.S. Provisional Application Ser. No. 63/382,279, entitled “Smart Glass with Wireless Power Sources,” filed Nov. 3, 2022, and which is hereby incorporated herein by reference in its entirety.

### FIELD OF THE DISCLOSURE

The present disclosure is directed to a smart glass system, and more specifically to a smart glass system with multiple power sources and for mounting on a window or a window frame.

### BACKGROUND

Smart glass may be used to decrease heat transfer through a window and/or reduce the transmission of visible light to provide tinting or shading. A smart glass system including a smart glass (e.g., an electrochromic (EC) device, an electrochromic insulated glass unit (EC-IGU), a device with a glass that changes, for example tint, in response to an input, an electrical charge, and/or the environment) may be used to provide a decrease in thermal conductivity (e.g., increase in insulation) through a transparent substrate and a reduction in visible light transmission through a transparent substrate (e.g., a window or glass pane). An EC device may include EC materials that are known to change their optical properties, such as coloration, in response to the application of an electrical potential, thereby making the transparent substrate more or less transparent or more or less reflective. An EC device can also change its optical properties such as optical transmission, absorption, reflectance and/or emittance in a continual but reversible manner on application of voltage. These properties enable the EC device to be used for applications like smart glasses, EC mirrors, EC display devices, and the like. EC glass may include a type of glass or glazing for which light transmission properties of the glass or glazing are altered when electrical power (e.g., voltage/current) is applied to the glass. EC materials may change in opacity (e.g., may changes levels of tinting) when electrical power is applied. Adding or replacing windows or glass panes with integrated smart glass may be time consuming, labor intensive, and costly.

### SUMMARY

A free-standing smart glass system may be provided for installation on or attachment to one or more existing windows or glass panes. The smart glass system may include a smart glass (e.g., an electrochromic (EC) device, an electrochromic insulated glass unit (EC-IGU), a device with a glass that changes, for example, tint in response to an input, an electrical charge, and/or the environment) and a smart glass frame retaining (e.g., supporting) the smart glass. The smart glass system may be sized and/or shaped so that the smart glass frame aligns with, fits within, or fits around a frame of an existing window (e.g., a window frame). One or more mounting devices of the smart glass frame may attach the smart glass frame to the window frame to secure the smart glass system to the window. For example, a smart glass frame may be sized and shaped to have a same size and a same shape as a window frame. One or more mounting devices fixedly attached to the smart glass frame may grip the window frame to align the smart glass frame with the window frame so that the smart glass frame overlaps with an outward facing surface of the window frame (e.g., parallel to a surface of the window) and to secure the smart glass system to the window. As another example, a smart glass frame may be sized and shaped to have a larger size and a same shape as a window frame. One or more mounting devices fixedly attached to the smart glass frame may grip the window frame to position the smart glass frame around the window frame so that the smart glass frame is adjacent an outer surface of the window frame (e.g., orthogonal to a surface of the window) and to secure the smart glass system to the window. As yet another example, a smart glass frame may be sized and shaped to have a smaller size and a same shape as a window frame. One or more mounting devices fixedly attached to the smart glass frame may grip the window frame to position the smart glass frame within the window frame so that the smart glass frame is adjacent an inner surface of the window frame (e.g., orthogonal to a surface of the window) and to secure the smart glass system to the window. In some aspects, the smart glass frame may be sized and shaped to be positioned securely within the window frame or around an outside surface of the window frame to secure the smart glass system to the window without using mounting device.

In some aspects, the one or more mounting devices may include one or more mounting brackets, one or more magnets, and/or one or more sides of the smart glass frame may be adjusted (e.g., extended or shortened) to tightly and securely fit around an existing window frame or tightly and securely fit within an existing window frame. In some aspects, the smart glass system, after being mounted on an existing window frame, may be removed for adjustment and/or repair and subsequently remounted on the existing window frame without affecting the structure or function of the existing window or window frame. In some aspects, the smart glass system, after being mounted on an existing window frame, may be removed and subsequently replaced with another smart glass system without affecting the structure or function of the existing window or window frame. In some aspects, gaskets and/or seals may be positioned between the smart glass system and the window frame.

### BRIEF DESCRIPTION OF THE DRAWINGS

FIG. 1 illustrates a block diagram of an example smart glass system according to some aspects of this disclosure.

FIG. 2 illustrates a perspective view of an example system including a smart glass system for attachment to a window frame according to some aspects of this disclosure.

FIG. 3A illustrates a side view of an example system including a smart glass system being mounted to a window frame according to some aspects of this disclosure.

FIG. 3B illustrates a side view of an example system including a smart glass system mounted to a window frame according to some aspects of this disclosure.

FIG. 4A illustrates a perspective view of an example system including a smart glass system mounted to a window frame according to some aspects of this disclosure.

FIG. 4B illustrates a side view of the example system including the smart glass system mounted to the window frame according to some aspects of this disclosure.

FIG. 5 illustrates a perspective view of an example system including a smart glass system for attachment to a plurality of window frames according to some aspects of this disclosure.

FIG. 6 illustrates a perspective view of an example smart glass system having one or more photovoltaic panels according to some aspects of this disclosure.

FIG. 7 illustrates another perspective view of an example smart glass system having one or more photovoltaic panels according to some aspects of this disclosure.

FIG. 8 illustrates another perspective view of an example smart glass system having one or more photovoltaic panels according to some aspects of this disclosure.

FIG. 9 illustrates a side view of an example system including a smart glass system mounted to a window frame and including one or more photovoltaic panels according to some aspects of this disclosure.

FIG. 10 illustrates another perspective view of an example smart glass system having one or more smart glass-integrated photovoltaic panels according to some aspects of this disclosure.

FIG. 11 illustrates a perspective view of an example smart glass system having one or more photovoltaic panels mounted to a window frame according to some aspects of this disclosure.

FIG. 12 illustrates a perspective view of an example smart glass system having one or more focusing optics mounted to a window frame according to some aspects of this disclosure.

FIG. 13 illustrates a side view of an example system including a smart glass system mounted to a window frame and including one or more photovoltaic panels mounted in an exterior region according to some aspects of this disclosure.

FIG. 14 illustrates a perspective view of an example smart glass system having one or more power receivers mounted to a smart glass frame according to some aspects of this disclosure.

FIG. 15 illustrates a perspective view of another example smart glass system having one or more power receivers mounted to a smart glass frame according to some aspects of this disclosure.

FIG. 16 illustrates a perspective view of an example smart glass system having one or more solar panels and one or more wireless power receivers mounted to the smart glass frame according to some aspects of this disclosure.

FIG. 17A illustrates a perspective view of an example smart glass system including a smart glass frame having one or more compartments according to some aspects of this disclosure.

FIG. 17B illustrates a side view of an example smart glass system including a smart glass frame having one or more compartments according to some aspects of this disclosure.

FIG. 18A illustrates a perspective view of an example smart glass system including a smart glass frame having one or more compartments according to some aspects of this disclosure.

FIG. 18B illustrates a side view of an example smart glass system including a smart glass frame having one or more compartments according to some aspects of this disclosure.

FIG. 19 illustrates a side view of an example system including a smart glass system mounted to a window frame and including one or more power transmitters for providing wireless power to one or more power receivers of the smart glass system according to some aspects of this disclosure.

FIG. 20A illustrates a perspective view of an example smart glass system having one or more user interfaces according to some aspects of this disclosure.

FIG. 20B illustrates a side view of an example smart glass system having one or more user interfaces according to some aspects of this disclosure.

FIG. 21 illustrates a perspective view of an example system including a plurality of smart glass systems in electronic communication with a user terminal according to some aspects of this disclosure.

FIG. 22 illustrates a perspective view of an example EC system according to some aspects of this disclosure.

FIG. 23 is a block diagram illustrating a computer system according to various embodiments, as well as various other systems, components, services or devices described above.

This specification may include references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value. It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will further be understood that the term “or” as used herein refers to and encompasses alternative combinations as well as any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. For example, the words “include,” “including,” and “includes” indicate open-ended relationships and therefore mean including, but not limited to. Similarly, the words “have,” “having,” and “has” also indicate open-ended relationships, and thus mean having, but not limited to.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Whenever a relative term, such as “about,” “substantially” or “approximately,” is used in this specification, such a term should also be construed to also include the exact term. That is, e.g., “substantially straight” should be construed to also include “(exactly) straight.” As used herein, the terms “about”, “substantially”, or “approximately” (and other relative terms) may be interpreted in light of the specification and/or by those having ordinary skill in the art. In some examples, such terms may as much as 1%, 3%, 5%, 7%, or 10% different from the respective exact term.

While embodiments are described herein by way of example for several embodiments and illustrative drawings, those skilled in the art will recognize that the embodiments are not limited to the embodiments or drawings described. It should be understood that the drawings and detailed description thereto are not intended to limit embodiments to the particular form disclosed, but on the contrary, the intention is to cover all modifications, equivalents and alternatives falling within the spirit and scope as defined by the appended claims. Any headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must).

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION

A free-standing smart glass system may be provided for installation on or attachment to one or more existing windows or glass panes. The smart glass system may include a smart glass (e.g., an electrochromic (EC) device, an electrochromic insulated glass unit (EC-IGU), a device with a glass that changes, for example tint, in response to an input, an electrical charge, and/or the environment) and a smart glass frame retaining (e.g., supporting) the smart glass. The smart glass system may be sized and/or shaped so that the smart glass frame aligns with, fits within, or fits around a frame of an existing window (e.g., a window frame). One or more mounting devices of the smart glass frame may attach the smart glass frame to the window frame to secure the smart glass system to the window. For example, a smart glass frame may be sized and shaped to have a same size and a same shape as a window frame. One or more mounting devices fixedly attached to the smart glass frame may grip the window frame to align the smart glass frame with the window frame so that the smart glass frame overlaps with an outward facing surface of the window frame (e.g., parallel to a surface of the window) and to secure the smart glass system to the window. As another example, a smart glass frame may be sized and shaped to have a larger size and a same shape as a window frame. One or more mounting devices fixedly attached to the smart glass frame may grip the window frame to position the smart glass frame around the window frame so that the smart glass frame is adjacent an outer perimeter surface of the window frame (e.g., orthogonal to a surface of the window) and to secure the smart glass system to the window. As yet another example, a smart glass frame may be sized and shaped to have a smaller size and a same shape as a window frame. One or more mounting devices fixedly attached to the smart glass frame may grip the window frame to position the smart glass frame within the window frame so that the smart glass frame is adjacent an inner perimeter surface of the window frame (e.g., orthogonal to a surface of the window) and to secure the smart glass system to the window. In some aspects, the smart glass frame may be sized and shaped to be positioned securely within the window frame or around an outside surface of the window frame to secure the smart glass system to the window without using mounting devices. In some aspects, the one or more mounting devices may include one or more mounting brackets, one or more magnets, and/or one or more sides of the smart glass frame may be adjusted (e.g., extended or shortened) to tightly and securely fit around an existing window frame or tightly and securely fit within an existing window frame. In some aspects, the smart glass system, after being mounted on an existing window frame, may be removed for adjustment and/or repair and subsequently remounted on the existing window frame without affecting the structure or function of the existing window or window frame. In some aspects, the smart glass system, after being mounted on an existing window frame, may be removed and subsequently replaced with another smart glass system without affecting the structure or function of the existing window or window frame.

The smart glass system may include one or more power receiving devices for receiving and providing power to a smart glass (e.g., electrochromic device) to increase or maintain a level of tinting of the smart glass. For example, the one or more power receiving devices may include one or more solar panels (e.g., photovoltaic panels) positioned on and/or around the smart glass frame, on and/or around the window frame, or at one or more locations that receive sun exposure (e.g., one or more locations at an exterior or outdoor region/area). In some aspects, one or more solar panels may be positioned within the smart glass. For example, one or more transparent or translucent solar panels may be positioned within the smart glass around a perimeter of the smart glass (e.g., near the smart glass frame) and/or at one or more light obstruction points on the smart glass. Additionally, or alternatively, the one or more power receiving devices may include one or more wireless power receivers (e.g., one or more wireless receivers, one or more wireless transceivers). The wireless power receiver(s) may be positioned on a surface of the smart glass frame, in a compartment within the smart glass frame, and/or positioned at a location near the smart glass system (e.g., on a building wall near the smart glass system, on a ceiling near the smart glass system, on a floor near the smart glass system, or beneath a floor near a smart glass system). The one or more power receiver(s) may receive wireless power from one or more wireless transmitters (e.g., wireless transceiver(s)) positioned near the smart glass system (e.g., within an interior region/area of a building, in an exterior region/area outside a building). For example, the one or more wireless transmitters may be positioned at a central or suitable location (e.g., having wireless transmission path(s) or direction(s) to the smart glass systems that are minimally obstructed) near and/or amongst a plurality of smart glass systems to distribute wireless power to the wireless power receiver(s) of the respective smart glass systems. Additionally, or alternatively, the smart glass system and/or the one or more wireless transmitters may include one or more power communication lines. The power communication lines may include a power communication line provided through a data communication cable (e.g., an ethernet cable) and/or one or more dedicated power communication lines.

The smart glass system may include one or more controllers. The controller(s) may be positioned in a compartment within the smart glass frame and/or positioned at a location on or near the smart glass system (e.g., above a ceiling in a ceiling space of a building, on a wall of a building, on a floor of a building, or beneath of a floor of a building). The controller(s) may control power to the smart glass. For example, when the smart glass is to increase or maintain a tint, the controller may direct power from one or more power receiving devices to the smart glass to increase or maintain a level of tint of the smart glass. As another example, when the smart glass is to decrease tint, the controller may direct power from one or more power receiving device away from the smart glass to decrease a level of tint of the smart glass. In some aspects, the smart glass system may include a power storage device (e.g., a battery, a capacitor, or the like). The power storage device may be positioned in a compartment within the smart glass frame or at a location on or near the smart glass system (e.g., on the smart glass frame, on a wall near the smart glass system, above a ceiling in a building at least location near the smart glass, on a floor of a building at a location near the smart glass system, beneath of a floor of a building at a location near the smart glass system). The power storage device may receive power through/from one or more power receiving device(s) and store the received power for subsequent use. For example, the controller(s) may direct power from at least one power receiving device to the power storage device to store power within the power storage device for subsequent use. As described herein, the controller(s) may control power to the smart glass. Thus, the controller(s) may direct power from the power storage device to the smart glass to maintain or increase a level of tint of the smart glass. In some aspects, the controller(s) may direct different amounts of power from individual power receiving device(s) to the power storage device and to the smart glass based on an amount of power received from individual power receiving device(s), a schedule, one or more sensed conditions (e.g., sensed by one or more sensor), one or more current conditions of the power storage device and/or the power receiving device(s), and/or one or more predetermined parameters for the power storage device and/or the smart glass. Similarly, the controller(s) may direct different amounts of power from individual power receiving device(s) and the power storage device to the smart glass based on an amount of power received from individual power receiving device(s), a schedule, one or more sensed conditions (e.g., sensed by one or more sensor), one or more current conditions of the power storage device and/or the power receiving device(s), and/or one or more predetermined parameters for the power storage device and/or the smart glass. In some aspects, the one or more power receiving devices, the one or more power storage devices, and the one or more wired power sources may generally be called power sources.

The smart glass system described herein may be a free-standing retrofit system for installation on or attachment to one or more existing windows or glass panes. The smart glass system may be installed on or attached to an existing window or glass pane while minimizing the amount of wiring needed for installation or attachment. Depending on the application, the smart glass system may be installed on either the outside or inside of an existing window. In some aspects, the smart glass system may be sized and shaped to fit over a single existing window or multiple existing windows at the same time. In some aspects, the smart glass system may include a user interface accessible directly through the smart glass, located on a portion of the smart glass frame, and/or accessible wirelessly using a user terminal for immediate programming and without the need to attach the smart glass to a network of any kind. The user interface may include a touch screen, one or more physical buttons, a display, one or more indicators, or the like.

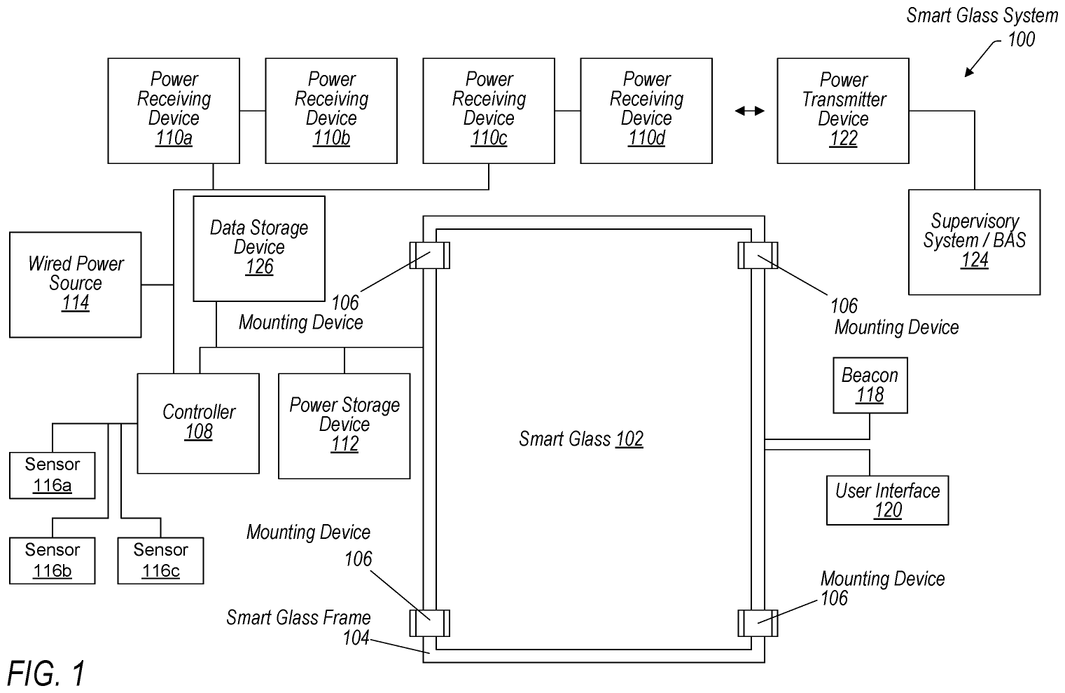

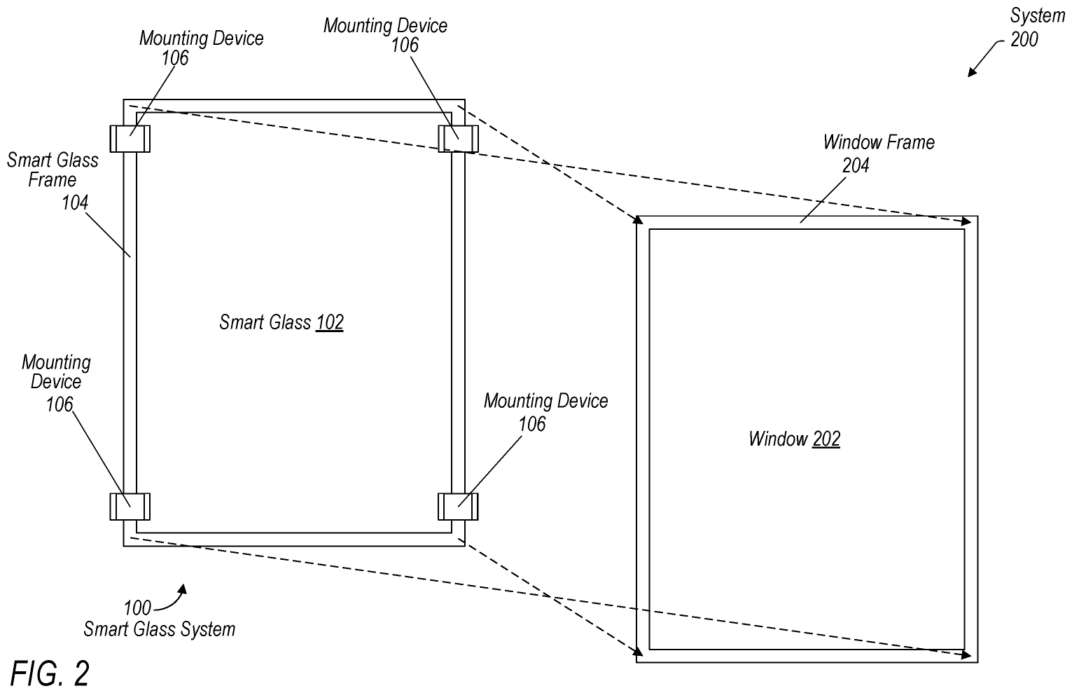

FIG. 1 illustrates a perspective view of an example insulated glass unit (smart glass) system according to some aspects of this disclosure. The smart glass system 100 may include one or more same or similar features as the features described with respect to or illustrated in FIGS. 2, 3A, 3B, 4A, 4B, 5, 6, 7, 8, 9, 10, 11, 12, 13, 14, 15, 16, 17A, 17B, 18A, 18B, 19, 20A, 20B, 21, 22, and 23. FIG. 1, as with the other included figures, is shown for illustrative purposes and does not limit either the possible embodiments of the present invention or the claims. In the example illustrated in FIG. 1, the smart glass system 100 may include a smart glass device 102 (e.g., an electrochromic device) (hereinafter the “smart glass”) retained by or held within a smart glass frame 104. The smart glass frame 104 may contain one or more mounting devices 106. The one or more mounting devices 106 may attach the smart glass frame (and thus the smart glass) to a window frame to secure the smart glass 102 and the smart glass frame 104 to the window. For example, the smart glass frame 104 may be sized and shaped to have a same size and a same shape as a window frame. The one or more mounting devices 106 fixedly attached to the smart glass frame 104 may grip the window frame to align the smart glass frame 104 with the window frame so that the smart glass frame 104 overlaps with an outward facing surface of the window frame (e.g., parallel to a surface of the window) and to secure the smart glass system 100 to the window.

As another example, a smart glass frame 104 may be sized and shaped to have a larger size and a same shape as a window frame. The one or more mounting devices 106 fixedly attached to the smart glass frame 104 may grip the window frame to position the smart glass frame 104 around the window frame so that the smart glass frame 104 is adjacent an outer surface of the window frame (e.g., orthogonal to a surface of the window) and to secure the smart glass system to the window. As yet another example, a smart glass frame 104 may be sized and shaped to have a smaller size and a same shape as a window frame. The one or more mounting devices 106 fixedly attached to the smart glass frame 104 may grip the window frame to position the smart glass frame 104 within the window frame so that the smart glass frame 104 is adjacent to an inner surface of the window frame (e.g., orthogonal to a surface of the window) and to secure the smart glass system 100 to the window. In some aspects, the smart glass frame 104 may be sized and shaped to be positioned securely within the window frame or around an outside surface of the window frame to secure the smart glass system 100 to the window without using mounting devices. In some aspects, the one or more mounting devices may include one or more mounting brackets, one or more magnets, and/or one or more sides of the smart glass frame 104 may be adjusted (e.g., extended or shortened) to tightly and securely fit around an existing window frame or tightly and securely fit within an existing window frame. In some aspects, the smart glass system 100, after being mounted on an existing window frame, may be removed for adjustment and/or repair and subsequently remounted on the existing window frame without affecting the structure or function of the existing window or window frame. In some aspects, gaskets and/or seals may be positioned between the smart glass system and the window frame. In some aspects, the smart glass system 100, after being mounted on an existing window frame, may be removed and subsequently replaced with another smart glass system without affecting the structure or function of the existing window or window frame. In some aspects, photovoltaic panels as described herein could be mounted to an existing window frame, and the smart glass system 100 could connect to the photovoltaic panels both mechanically and electrically, for example with spring pins, magnetic connectors, or other means of making electrical and mechanical connections simultaneously.

The smart glass system 100 may also include one or more power receiving devices 110 for receiving and providing power to the smart glass 102 to increase or maintain a level of tinting of the smart glass 102. As shown in FIG. 1, the smart glass system 100 may include a first power receiving device 110a, a second power receiving device 110b, a third power receiving device 110c, and a fourth power receiving device 110d. In some aspects, the one or more power receiving devices 110 may include one or more solar panels (e.g., photovoltaic panels) positioned on and/or around the smart glass frame 104, on and/or around the window frame, or at one or more locations that receive sun exposure (e.g., one or more locations at an exterior or outdoor region/area). In some aspects, one or more solar panels may be positioned within the smart glass 102. For example, one or more transparent or translucent solar panels may be positioned within the smart glass 102, around a perimeter of the smart glass 102 (e.g., near the smart glass frame 104), and/or at one or more obstruction areas on the smart glass 102. For example, in addition to or as an alternative to discrete solar panels, transparent or semi-transparent solar panels over a vision area of the smart glass 102 may be positioned either on a surface of the smart glass 102 and/or at one or more locations within the smart glass 102. These could also be opaque if only covering part of the area, or located on a spacer.

In some aspects, when positioning solar panels on the smart glass frame 104, multiple solar panels may be selectively positioned to capture solar energy at different times of the day or with different solar angles. For example, a solar panel positioned at a lower side of the smart glass frame 104 with a horizontal orientation may capture high-angle sun, while a solar panel positioned on a side of the smart glass frame 104 with a vertical orientation may capture low-angle sun. Positioning the smart glass frame 104 east facing or west facing may mean that the solar panels are located on a north vertical side of the smart glass frame 104 but not the south side vertical side of the smart glass (which may usually be shaded), and the north one might face nearly outward to capture low-angle sun well. Or instead of being angled, there could be solar panels on two surfaces, one facing outward and one facing south. For a smart glass frame facing to the south, there may be panels on both the left and right side, nearly flat against the frame to capture low-angle sun which is not coming from directly outward. Solar panel orientation may be adjusted either manually or automatically for a specific application. In some aspects, focusing or reflecting optics may be used to direct sunlight onto a solar panel permitting the use of smaller solar panels. The focusing optics or reflecting optics may re-direct IR or UV light without affecting visible light. For example, reflective surfaces located outside the smart glass system 100 may direct more light onto a surface of the solar panel. In some aspects, solar panel surfaces may be positioned or orientated to capture interior energy (e.g., light from within a building) as well as external energy (e.g., light from outside a building).

Additionally, or alternatively, the one or more power receiving devices may include one or more wireless power receivers (e.g., one or more wireless receivers, one or more wireless transceivers). The wireless power receiver(s) may be positioned on a surface of the smart glass frame 104, in a compartment within the smart glass frame 104, and/or positioned at a location near the smart glass system 100. In some cases, a building may have few wireless power transmitters none of which are close enough to the smart glass 102 and/or the smart glass frame 104 to provide wireless power transmission to a wireless power receiver mounted on and/or within the smart glass 102 and/or the smart glass frame 104. One or more wireless power receivers may be positioned, for example, on a building wall near the smart glass system, on a ceiling near the smart glass system, on a floor near the smart glass system, or beneath a floor near a smart glass system, with minimal wiring between the wireless power receiver and the smart glass 102 and/or the smart glass frame 104 so that a wireless power transmitter may transmit wireless power to the wireless power receiver. The one or more power receiver(s) may receive wireless power from one or more power transmitter devices 122 (e.g., wireless transceiver(s)) positioned near the smart glass system 100 (e.g., within an interior region/area of a building, in an exterior region/area outside a building). For example, the one or more power transmitter devices 122 may be positioned at a central or suitable location (e.g., having wireless transmission path(s) or direction(s) to the smart glass systems that are minimally obstructed) near and/or amongst a plurality of smart glass systems to distribute wireless power to the wireless power receiver(s) of the respective smart glass systems. Further, reflective surfaces may be used to re-focus the wirelessly transferred energy from the power transmitter device(s) 122 to the wireless receiver(s) to improve efficiency without increasing antenna size. In some aspects, if the power transmitter device(s) 122 provided wireless power to the smart glass system 102, via the wireless receiver(s), is powered by low-voltage direct current (DC), power sources may be easily added or changed without requiring a high-voltage electrician for the installation or move.

When the power receiving devices 110 includes wireless transceivers, the controller 108 may utilize the wireless transceiver to communicate data with one or more other smart glass systems, a building automation system (BAS), and/or a user interface (UI) 120 (e.g., a portable electronic device, a user terminal). For example, a smart glass system 100 may utilize wireless transceivers to communicate with one or more smart glass systems via a first wireless network (e.g., a wireless local area network (WLAN), a BAS or supervisor system 124 via a second wireless network (e.g., another WLAN), and/or a UI via a third wireless network (e.g., near-field communication). In some aspects, the wireless power receivers (e.g., transceivers), may be used as occupancy sensors to directly determine that a path to one or more windows has been interrupted. This information may be used to control (e.g., change or maintain) a tint of the smart glass 102 of the smart glass system 100. Additionally, or alternatively, the smart glass system 100 may include one or more wired power sources 114. For example, the one or more wired power sources 114 may include one or more power communication lines. The power communication lines may include a power communication line provided through a data communication cable (e.g., an ethernet cable) and/or one or more dedicated power communication lines. The wired power sources 114 may include an AC and/or DC current and may provide relatively higher voltage and/or relatively lower voltage.

When a system includes a plurality of smart glass systems, a power transmitter device 122 (e.g., a wireless power transmitter) may be controlled to provide power only when and where needed instead of equally splitting transmitting between a plurality of wireless power receivers. The power transmitter device 122 (e.g., the supervisory system/BAS 124 in communication with the power transmitter device 122) may obtain information about the state of charge of a power storage device for each smart glass system, for example, and provide power on that basis (for instance, always transmitting power to the smart glass system with the lowest state of charge.) The power transmitter device 122 (e.g., the supervisory system/BAS 124 in communication with the power transmitter device 122) may also obtain information about a recent history of each smart glass's power available from the environment (like solar power) and provide power based on this. For instance, the power transmitter device 122 (e.g., the supervisory system/BAS 124 in communication with the power transmitter device 122) may determine from recent power availability and a power storage device state of charge which smart glass system is likely to run out of power in the future, and provide power on that basis. If the power transmitter device (e.g., the supervisory system/BAS 124 in communication with the power transmitter device 122) is connected to the internet or other source of weather forecast information, the power transmitter device 122 may include this in the algorithm, attempting to limit wireless power transfers if the next day will be sunny, or conserving power if a week of heavily overcast skies is projected.

With respect to at least the case when the one or more power receiving devices include at least one solar panel, an internal retrofit smart glass system that utilizes solar power may have shading from multiple directions, for example, as the sun's position relative to the smart glass system changes. The smart glass system 100 (and other smart glass systems described herein) may have multiple wireless power receiving devices 110 (e.g., solar panels, wireless power receivers) located on different edges of the smart glass frame 104 and/or the smart glass 102. Further, when the power receiving devices include solar panels, each of the solar panel surfaces and smart glass frame surfaces may face in a variety of different directions and orientations. In addition, the solar panels may be connected to the electronics of the smart glass system 100 (e.g., the controller 108, the smart glass 102) in such a way that if one solar panel is providing very low power, another solar panel may still be fully utilized. Also, even within one solar panel with a common edge and facing orientation, shadowing may affect part of the solar panel but not all of the solar panel. When the solar panels (or cells) are connected in series, the solar panels (or cells) may be limited to the available power of the lowest-producing panel (or cell). However, a single solar panel (or cell) with diode connections or in parallel may lead to very low output voltage and, as a result, can be difficult to work with and expensive with the numerous connections. Individual long and slender solar panels may be grouped into two or more groups of series-connected cells, with each group being connected to the electronics of the smart glass system 100 (e.g., the controller 108, the smart glass 102) to increase the efficiency of power harvesting (e.g., diode connections; or fully separate maximum power point tracking (MPPT) circuits; or the like.)

In some aspects, the first power receiving device 110a and the second power receiving device 110b may be aligned in series with each other and the third power receiving device 110c and the fourth power receiving device 110d may be aligned in series with each other. When those power receiving devices are solar panels, the power receiving devices electrically connected to each other in series may increase the efficiency of power harvesting (e.g., diode connections; or fully separate maximum power point tracking (MPPT) circuits; or the like) to the smart glass system 100 (e.g., the smart glass 102). In some aspects, the smart glass system 100 may have power receiving devices arranged with different configurations in series, in parallel, or a combination thereof which may be selected manually during commissioning (or adjusted later) to optimize for specific orientations, shading conditions, or the like. The smart glass system 100 (e.g., the controller 108) may manage the different configurations automatically. For example, the wiring for the power receiving devices may be arranged for both series and parallel operation. The controller 108 may designated which wires to communicate power to the smart glass 102 resulting in a series or parallel electrical communication configuration.

The smart glass system 100 may further include one or more controllers 108. The controller(s) 108 may be positioned in a compartment within the smart glass frame 104 and/or positioned at a location on or near the smart glass system 100. The controller(s) 108 may control power to the smart glass 102. For example, when the smart glass 102 is to increase or maintain a tint, a controller 108 may direct power from one or more power receiving devices 110 (or the wired power source(s) 114) to the smart glass 102 to increase or maintain a level of tint of the smart glass 102. As another example, when the smart glass 102 is to decrease tint, a controller 108 may direct power from one or more power receiving device (or the wired power source(s) 114) away from the smart glass 102 to decrease a level of tint of the smart glass 102.

In the case of power outage and losing a wireless power source, the controller 108 of the smart glass system 100 may enter a low-power mode in various ways. In some aspects, if there is a wired supervisory system 124, the controller 108 of the smart glass system 100 may automatically enter an alternate mode of operation where some reduced level of automation and manual control may be supported using only the controller 108 and a user interface 120 (e.g., as a mobile device). For example, a controller 108 of each smart glass system 100 may begin autonomously responding to sunlight directly, or a controller 108 of a smart glass system 100 may share daylight data and smart glass systems 100 in an operating zone may tint together based on the highest reading, with manual control from a user interface 120.

The controller 108 may be configured to manage power flow between power sources and the smart glass 102. For example, the controller 108 may be configured to manage power flow between a plurality of power receiving devices 110 (e.g., one or more solar panels, one or more wireless power receivers), one or more power storage devices 112, one or more wired power sources 114, and the smart glass 102. In some aspects, the controller 108 may be configured to allocate or direct power from one or more power receiving devices 110 to the power storage device(s) 112 and/or the smart glass 102. In some instances, the controller 108 may direct power from the one or more power receiving devices 110 to the power storage device(s) 112 to charge the power storage device(s) 112. For example, the controller 108 may determine that at least one power storage device 112 is not fully charged and/or is below a level of charge to increase a level of tint of the smart glass 102 (e.g., make the smart glass darker), decrease a level of tint of the smart glass 102 (e.g., make the smart glass less dark), or maintain a level of tint of the smart glass 102. Accordingly, the controller 108 may direct power from at least one power receiving device 110 of the one or more power receiving devices 110 to the power storage device 112 to charge the power storage device 112. In some instances, the controller 108 may direct a portion of the power from the one or more power receiving devices 110 to the power storage device(s) 112 to charge the power storage device(s) 112 and direct another portion of the power (e.g., a remaining amount of power) from the one or more power receiving devices 110 to the smart glass 102 to control a level of tint of the smart glass 102. For example, the controller 108 may direct a portion of the power from the one or more power receiving devices 110 to the power storage device(s) 112 to charge the power storage device(s) 112 and direct another portion of the power from the one or more power receiving devices 110 to the smart glass to increase a level of tint of the smart glass 102 (e.g., make the smart glass darker), decrease a level of tint of the smart glass 102 (e.g., make the smart glass less dark), or the maintain a level of tint of the smart glass 102.

In some aspects, the controller 108 may be configured to allocate or direct power from one or more power receiving devices 110 to the power storage device 112 and/or the smart glass 102 based on a total amount of power received from the one or more power receiving devices 110 and a threshold amount of power. For example, the controller 108 may detect a total amount of power received from the one or more power receiving devices 110 and compare the total amount of power received from the one or more power receiving devices 110 with a threshold amount of power. When the total amount of power from at least the one or more power receiving devices 110 (e.g., one or more solar panels and/or one or more wireless power receivers) is above the threshold amount of power, the controller 108 may direct at least some power of the total amount of power to the one or more power storage devices 112 for charging. Additionally, or alternatively, when the total amount of power from at least the one or more power receiving devices 110 (e.g., one or more solar panels and/or one or more wireless power receivers) is above the threshold amount of power, the controller 108 may direct at least some power (e.g., a remaining amount of power) of the total amount of power to the smart glass 102 for controlling a level of tint of the smart glass 102.

In some aspects, the threshold amount of power may be based on at least one of a schedule, an amount of light detected by one or more sensors 116, an amount of light received by a solar panel, a user input through the user interface 120, and/or the like. The controller 108 may also identify a current level of tint of the smart glass 102 to determine an amount of power needed to transition the level of tint of the smart glass 102 from the current level of tint to the future level of tint. The controller 108 may determine the threshold amount of power based on the amount of power needed to transition the level of tint of the smart glass 102 from the current level of tint to the future level of tint. Additionally, or alternatively, the controller 108 may determine the threshold amount of power based on a transition speed (e.g., a specified transition speed, a user-provided transition speed) from a current level of tint to the future level of tint. In some aspects, for example, when the current level of tint is a same level of tint as the future level of tint, the controller 108 may determine the threshold amount of power based on an amount of power needed to maintain the level of tint of the smart glass 102. Additionally, or alternatively, the controller 108 may identify that the threshold amount of power is a predetermined threshold amount of power programmed into the controller 108.

In some aspects, the controller 108 may be configured to allocate or direct power from one or more power receiving devices 110 and/or the power storage device(s) 112 to the smart glass 102. In some instances, the controller 108 may direct power from the power storage device(s) 112 to the smart glass 102 to controller a level of tint of the smart glass 102. For example, the controller 108 may determine that at least one power storage device 112 has enough charge (e.g., power) and/or has at enough power to increase a level of tint of the smart glass 102 (e.g., make the smart glass darker), decrease a level of tint of the smart glass 102 (e.g., make the smart glass less dark), or maintain a level of tint of the smart glass 102. Accordingly, the controller 108 may direct power from the power storage device(s) 112 to the smart glass 102 to control a level of tint of the smart glass 102. In some instances, the controller 108 may direct power from the one or more power receiving devices 110 and the power storage devices 112 to the smart glass 102 to control a level of tint of the smart glass 102. For example, the controller 108 may direct power from one or more solar panels and/or one or more wireless power receivers and the power storage device(s) 112 to increase a level of tint of the smart glass 102 (e.g., make the smart glass darker), decrease a level of tint of the smart glass 102 (e.g., make the smart glass less dark), or maintain a level of tint of the smart glass 102.

In some aspects, the controller 108 may be configured to allocate or direct power from one or more power receiving devices 110 and/or the power storage device(s) 112 to the smart glass 102 based on a total amount of power received from the one or more power receiving devices 110 and the threshold amount of power. For example, the controller 108 may detect the total amount of power received from the one or more power receiving devices 110 and compare the total amount of power received from the one or more power receiving devices 110 with the threshold amount of power. When the total amount of power from at least the one or more power receiving devices 110 (e.g., one or more solar panels and/or one or more wireless power receivers) is not above the threshold amount of power, the controller 108 may direct at least some power from the power storage devices 112 to the smart glass 102 for controlling a level of tint of the smart glass 102. Additionally, or alternatively, when the total amount of power from at least the one or more power receiving devices 110 (e.g., one or more solar panels and/or one or more wireless power receivers) is not above the threshold amount of power, the controller 108 may direct power (e.g., the total amount of power) from the one or more power receiving device 110 to the smart glass 102 for controlling a level of tint of the smart glass 102.

In some aspects, the controller 108 may be configured to direct or allocate at least some power of the total amount of power from at least one or more solar panels and one or more wireless power receivers to the one or more power storage devices 112 for charging the one or more power storage device 112 when a total amount of power from at least the one or more solar panels and the one or more wireless power receivers is above the threshold amount of power, and direct or allocate at least some power from the one or more power storage devices 112 to the smart glass 102 for controlling a level of tint of the smart glass 102 when the total amount of power from at least the one or more solar panels and the one or more wireless power receivers is not above the threshold amount of power. Additionally, or alternatively, when the total amount of power from at least the one or more solar panels and the one or more wireless power receivers is above the threshold amount of power, the controller 108 may be configured to direct or allocate at least some power of the total amount of power to the smart glass 102 for controlling the level of tint of the smart glass 102. Additionally, or alternatively, when the total amount of power from at least the one or more solar panels and the one or more wireless power receivers is not above the threshold amount of power, the controller 108 may be configured to direct or allocate the total amount of power to the smart glass 102 for controlling the level of tint of the smart glass 102.

In some aspect, as described herein, the smart glass system 100 may include one or more sensors. The controller 109 may receive one or more input parameters (e.g., an amount of light received by the sensors) from the one or more sensors, determine the amount of tint for the smart glass based on the one or more input parameters, and control the amount of power delivered to the smart glass from the one or more power receiving devices based on the amount of tint determined for the smart glass. In some aspects, the smart glass system 100 may include a user interface 120 for receiving one or tint parameters (e.g., an amount of tint request for a given amount of sunlight) for the smart glass 102. The controller 108 may determine the amount of tint for the smart glass 102 based on the one or more input parameters and the one or more tint parameters. In some aspects, the smart glass system 100 may include a data storage device 126 (e.g., within the controller 108) storing one or more predetermined parameters for the smart glass 102. The controller 108 may receive one or more predetermined parameters from the data storage device 126, determine the amount of tint for the smart glass 102 based on the one or more predetermined parameters, and control the amount of power delivered to the smart glass 102 from the one or more power receiving devices 110 based on the amount of tint determined for the smart glass 102. In some aspects, the smart glass system 100 may include a user interface 120 for receiving one or more tint parameters for the smart glass. The controller 108 may determine the amount of tint for the smart glass based on the one or more predetermined parameters and the one or more tint parameters received from the user interface 120, and control the amount of power delivered to the smart glass 102 from the one or more power receiving devices 110 based on the amount of tint determined for the smart glass.

In some aspects, the smart glass system 100 may include a power storage device 112 (e.g., a battery, a capacitor, or the like). In some aspects, a smart glass may utilize more power to transition rapidly from a lesser amount of tint or a lower tint level to a greater amount of tint or a greater tint level than to hold a given tint level. In some cases, it may be difficult to get enough peak power from a wireless power receiver continuously. Instead, a power storage device 112 may store charge from the intermittent (if environmentally sourced) or limited (if from a transmitter) (e.g., the power receiving devices 110) source, providing peak power when needed, or during times of low power availability. The power storage device 112 may be positioned in a compartment within the smart glass frame 104 or at a location on or near the smart glass system 100 (e.g., on the smart glass frame 104, on a wall near the smart glass system 100, above a ceiling in a building at least location near the smart glass system 100, on a floor of a building at a location near the smart glass system 100, beneath of a floor of a building at a location near the smart glass system 100).

In some aspects, when the smart glass system 100 relies on the power storage device 112 and the power storage device 112 has low power, a controller 108 of the smart glass system 100 may conserve power. For example, a controller 108 of the smart glass system 100 may stop the operation of the smart glass system 100 or reduce the rate of rate by which the smart glass changes tinting. In some aspects, a controller 108 of the smart glass system 100 may reduce the frequency of communication with a supervisor system or a building automation system (BAS) 124 (e.g., a central controller) and put the smart glass system 100 and the controller 108 to ‘sleep’ (enter a low-power mode). If the smart glass 102 of the smart glass system 100 has gradient tint levels requiring more power than uniform tint states, the controller 108 may temporarily disable the gradient tint states of the smart glass 102. In addition, the controller 108 or a transmitter may determine at a system level whether a given command (e.g., to tint a zone) can be adequately or marginally supported by available power and then either not execute the command, delay it, or slow down transitions if enough power is available in that way.

The power storage device 112 may receive power through/from one or more power receiving device(s) 110 (and/or the wired power source 114) and store the received power for subsequent use. For example, the controller(s) 108 may direct power from at least one power receiving device 110 to the power storage device 112 to store power within the power storage device 112 for subsequent use. As described herein, the controller(s) 108 may control power to the smart glass 102. Thus, the controller(s) 108 may direct power from the power storage device 112 to the smart glass 102 to maintain or increase a level of tint of the smart glass 102. In some aspects, the controller(s) 108 may direct different amounts of power from individual power receiving device(s) 110 to the power storage device 112 and to the smart glass 102 based on an amount of power received from individual power receiving device(s) 110, a schedule, one or more sensed conditions (e.g., sensed by one or more sensor 116), one or more current conditions of the power storage device 112 and/or the power receiving device(s) 110, and/or one or more predetermined parameters for the power storage device 112 and/or the smart glass 102. Similarly, the controller(s) 108 may direct different amounts of power from individual power receiving device(s) 110 and the power storage device 112 to the smart glass 102 based on an amount of power received from individual power receiving device(s) 110, a schedule, one or more sensed conditions (e.g., sensed by one or more sensor 116), one or more current conditions of the power storage device 112 and/or the power receiving device(s) 110, and/or one or more predetermined parameters for the power storage device 112 and/or the smart glass 102.

In addition, the smart glass system 100 may include one or more sensors 116. The one or more sensors 116 may include a first sensor 116a, a second sensor 116b, and a third sensor 116c. The one or more sensors 116 may sense a change in an amount of light that is received for the controller 108 to determine how much tinting the smart glass 102 is to have. For example, the one or more sensors 116 may be positioned on the smart glass frame 104, on a window frame, or at one or more locations in an exterior region of a building so that the one or more sensors 116 may be exposed to sunlight. When the one or more sensors 116 receive a relatively greater amount of light, the controller 108 may receive a signal from the one or more sensor 116 and determine to increase to or maintain a higher amount of tint of the smart glass 102. When the one or more sensors 116 receive a relatively lesser amount of light, the controller 108 may receive a signal from the one or more sensor 116 and determine to decrease to or maintain a lower amount of tint of the smart glass 102. In some aspects, the solar panels may be light/solar energy sensors to determine the amount of daylight and operate the smart glass system 100 or operating zone accordingly. If there are two or more solar panels with different locations or orientations, the smart glass system 100 can also infer information about the sun's location or direct solar intensity, in order to determine if there is a direct glare in the room which should be managed. For example, if there is a solar panel on the bottom facing up, and both sides facing in, at least one solar panel may also be shaded, and any solar panels in direct sun will produce far more power than the shaded solar panels. If there is no direct sun on that particular smart glass system 100, all solar panels may have similarly low levels of power production from diffuse energy. The controller 108 may know the exact orientation of each solar pane. If solar panels are adjustable, the controller 108 may measure the angle and position automatically.

As described herein, the smart glass system 100 may be a free-standing retrofit system for installation on or attachment to one or more existing windows or glass panes. After manufacturing but before shipping, a smart glass system 100 may be put in a very low-power mode to conserve a charge of the power storage device 112. Instead of a switch or button to ‘wake’ the smart glass system 100, the smart glass system 100 may periodically wake and check for some threshold of sunlight. If the smart glass system 100 detects a minimum threshold of sunlight, the smart glass system 100 may enter a normal operating mode. The smart glass system 100 may then perform a self-check of electronics (e.g., the controller 108), the power storage device 112, connections, or any other aspect of proper operation using one or more sensors or testing devices to indicate a fault or error immediately upon waking, whether the waking happens automatically or in response to a button, switch, or some other manual intervention. Before any kind of network or whole-system configuration, the smart glass system 100 may begin operating in an independent, autonomous mode (e.g., tinting based on available light at the solar panel), making it easy for an installer to verify functionality. The start-up mode may operate differently than normal automation, for example tinting slightly in the presence of even very low light, to allow this verification to occur under very cloudy conditions. In some aspects, the smart glass system 100 may wake in a commissioning mode, using a communication method such as a beacon 118 (e.g., a Bluetooth Low Energy (BLE) beacon) to determine which pane a portable electronic device (running a commissioning application) is very close to, and configure/commission that particular smart glass system 100 without having to select it from a list of available smart glass systems. For example, simply by walking around a room a user with a portable electronic device in wireless communication with a plurality of smart glass systems could automatically determine all the smart glass contained within a room and their ordering. Subsequently, the portable electronic device may transmit this information to a supervisory system 124 for configuration. In some aspects, the smart glass system 100 may be removed for maintenance or replacement. A supervisory system and/or a building automation system (BAS) 124 may recognize that a smart glass system 100 is no longer communicating on a network, and then that a new smart glass system 100 of the same size has appeared. The supervisor system and/or the BAS 124 may automatically map the replacement smart glass system 100 into the supervisory system and/or the BAS 124 to function exactly as the old smart glass system 100 did without additional user configuration.

In some aspects, the smart glass system 100 may be manufactured for the specific sizes. There could be a 1:1 plan, where each smart glass system 100 must be put in a specific location, even if sizes are the same, in order for a control system to know the physical locations for more optimal control. Additionally, or alternatively, the smart glass systems 100 may be installed arbitrarily (for same-size panes), and ‘pane mapping’ can be subsequently performed to map specific smart glass systems 100 to physical locations within a control system logic. This can be done by having a LED or other indicator identify a specific pane, and a person or automated camera system link the pane logically to its physical location, or to a specific operating/control zone. Alternatively, a wireless power transfer system can determine the angle and/or distance of each pane automatically based on its transfer of power and use communication to determine the sizes to create a visual map to set up zones for control.

FIG. 2 illustrates a perspective view of an example system 200 including a smart glass system 110 for attachment to a window frame 204 according to some aspects of this disclosure. The system 200 may include one or more same or similar features as the features described with respect to or illustrated in FIGS. 1, 3A, 3B, 4A, 4B, 5, 6, 7, 8, 9, 10, 11, 12, 13, 14, 15, 16, 17A, 17B, 18A, 18B, 19, 20A, 20B, 21, 22, and 23. FIG. 2, as with the other included figures, is shown for illustrative purposes and does not limit either the possible embodiments of the present invention or the claims. As shown in FIG. 2, the system 200 includes the smart glass system 100 and a window 202 contained within or retained by a window frame 204. The smart glass frame 104 may be aligned with the window frame 204 so that the smart glass 102 is aligned with the window 202. The mounting devices 106 fixedly attached to the smart glass frame 104 may grip the window frame 204 to securely attach the smart glass system 100 to the window frame 204 and the window 202. In some aspects, the mounting devices 106 allow for attachment of the smart glass system 100 to the window frame 204 and subsequent removal of the smart glass system 100 from the window frame 204. The smart glass system 100 may then be reattached to the window frame 204 or replaced with another smart glass system 100. The smart glass system 100 including the smart glass 102 may be positioned over the window 202 to provide tinting for the window 202.

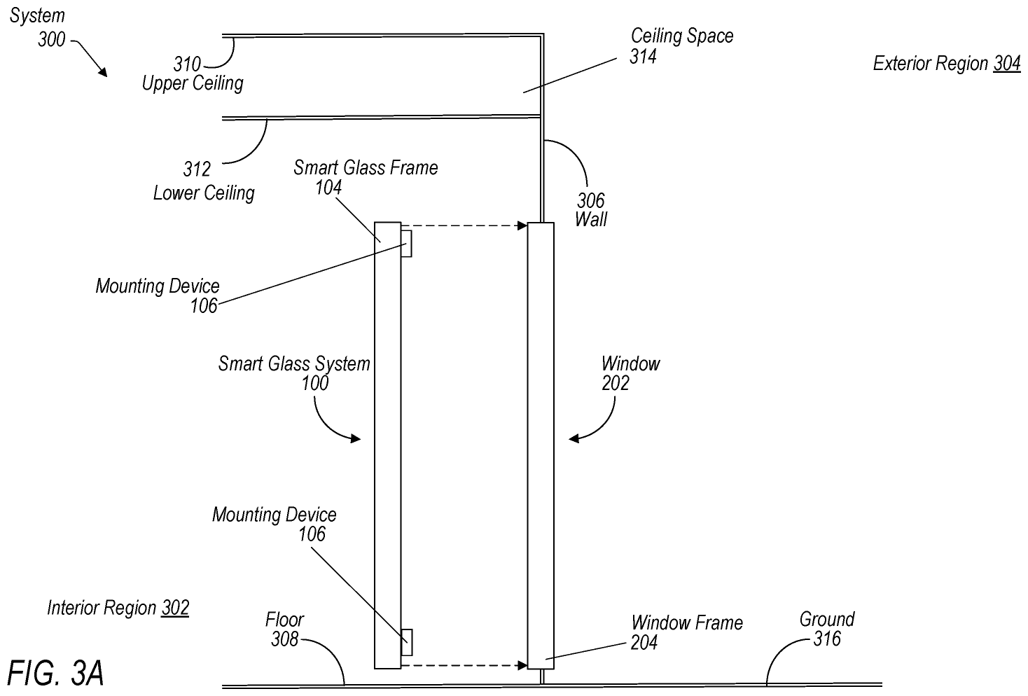

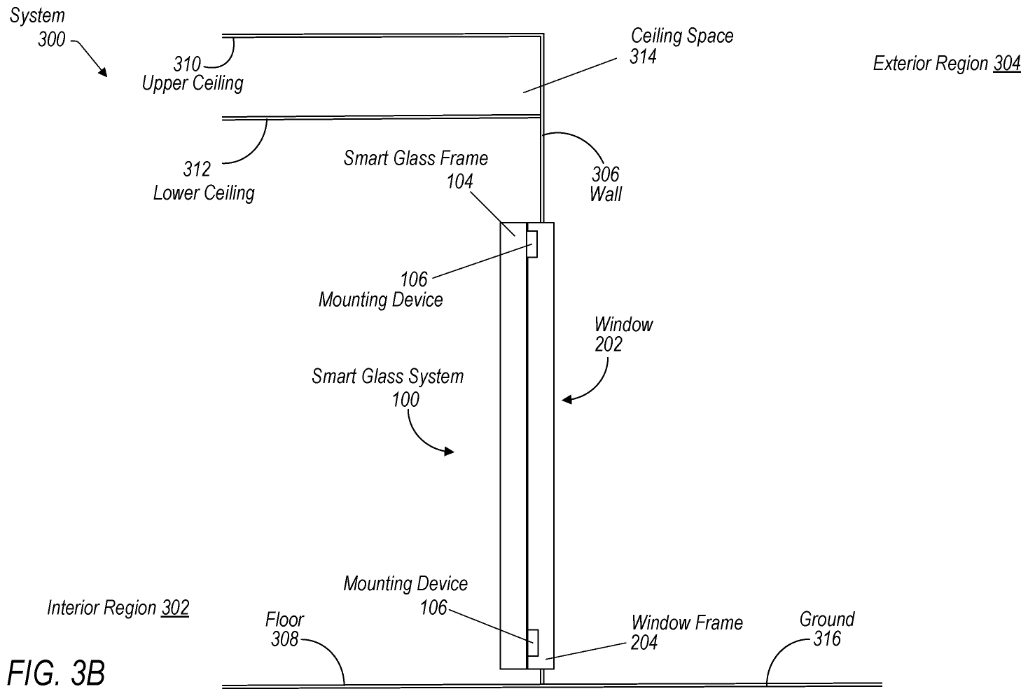

FIG. 3A illustrates a side view of an example system 300 including a smart glass system 100 being mounted to a window frame 204 according to some aspects of this disclosure. FIG. 3B illustrates a side view of the example system 300 including the smart glass system 100 mounted to a window frame 204 according to some aspects of this disclosure. The system 300 may include one or more same or similar features as the features described with respect to or illustrated in FIGS. 1, 2, 4A, 4B, 5, 6, 7, 8, 9, 10, 11, 12, 13, 14, 15, 16, 17A, 17B, 18A, 18B, 19, 20A, 20B, 21, 22, and 23. FIGS. 3A and 3B, as with the other included figures, is shown for illustrative purposes and does not limit either the possible embodiments of the present invention or the claims. As shown in FIG. 3A, the window frame 204 containing the window 202 may be retained in a wall 306 separating an interior region 302 from an exterior region 304. The interior region 302 may be the interior of a building. The interior region 302 may include the floor 308, an upper ceiling 310, a lower ceiling 312, and a ceiling space 314 formed by the wall 306, the upper ceiling 310 and the lower ceiling 312. The exterior region 304 may include ground 316 and may include one or more external light sources and particularly the sun. As shown in the FIG. 3A, the smart glass system 100 may be attached to the window frame 204 on an interior side of the window frame 204 using the mounting devices 106. In some aspects, the smart glass system 100 may be attached to the window frame 204 on an exterior side of the window frame using the mounting devices 106. As shown in FIG. 3B, the smart glass system 100 is attached to the window frame 204 on an interior side of the window frame 204 to provide tinting from the window 202.

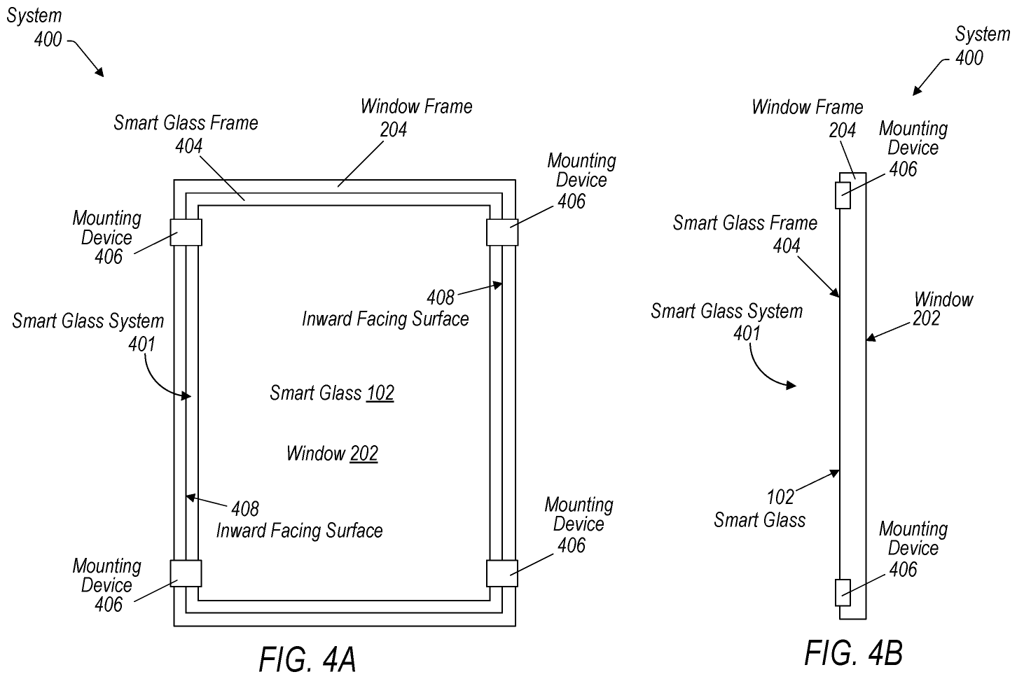

FIG. 4A illustrates a perspective view of an example system 400 including a smart glass system 401 mounted to a window frame 204 according to some aspects of this disclosure. FIG. 4B illustrates a side view of the example system 400 including the smart glass system 401 mounted to the window frame 204 according to some aspects of this disclosure. The system 400 may include one or more same or similar features as the features described with respect to or illustrated in FIGS. 1, 2, 3A, 3B, 5, 6, 7, 8, 9, 10, 11, 12, 13, 14, 15, 16, 17A, 17B, 18A, 18B, 19, 20A, 20B, 21, 22, and 23. FIGS. 4A and 4B, as with the other included figures, is shown for illustrative purposes and does not limit either the possible embodiments of the present invention or the claims. As shown in FIG. 4A, the system 400 may include smart glass system 401 and a window 202 with a window frame 204. The smart glass system 401 may include one or more same or similar features of the smart glass system 100 described and illustrated herein. For example, the smart glass system 401 may include a smart glass 102, a smart glass frame 204, and one or more mounting devices 406. The smart glass frame 204 may be sized and shaped to have a smaller size and a same shape as the window frame 204. The one or more mounting devices 406 fixedly attached to the smart glass frame 404 may grip the window frame 204 to position the smart glass frame 404 within the window frame 204 so that the smart glass frame 404 is adjacent an inner surface of the window frame 204 (e.g., orthogonal to a surface of the window) and to secure the smart glass system 100 to the window. As shown in FIGS. 4A and 4B, the mounting devices 406 may secure the smart glass frame 404 to the window frame 204 so that the smart glass frame 404 does not create additional depth for the window frame 204.

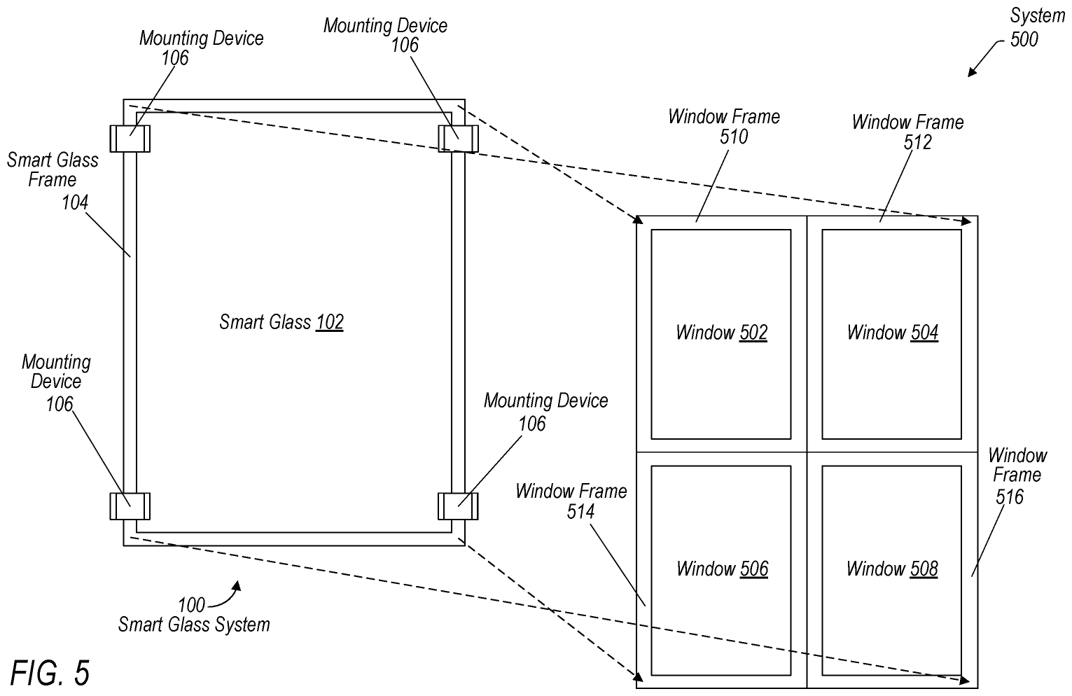

FIG. 5 illustrates a perspective view of an example system 500 including a smart glass system 100 for attachment to a plurality of window frames according to some aspects of this disclosure. The system 500 may include one or more same or similar features as the features described with respect to or illustrated in FIGS. 1, 2, 3A, 3B, 4A, 4B, 6, 7, 8, 9, 10, 11, 12, 13, 14, 15, 16, 17A, 17B, 18A, 18B, 19, 20A, 20B, 21, 22, and 23. FIG. 5, as with the other included figures, is shown for illustrative purposes and does not limit either the possible embodiments of the present invention or the claims. As shown in FIG. 5, the system may include the smart glass system 100 and a plurality of windows. The smart glass system 100 may be sized and shaped to be positioned over the plurality of windows. For example, a plurality of windows may include a first window 502 having a first window frame 510, a second window 504 having a second window frame 512, a third window 506 having a third window frame 514, and a fourth window 508 having a fourth window frame 516. The smart glass system 100 may have four mounting devices 106 that each grip a frame of a respective window so that the smart glass system 100 may attach to the plurality of frames and the smart glass 102 may provide tinting to the first window 502, the second window 504, the third window 506, and the fourth window 508.

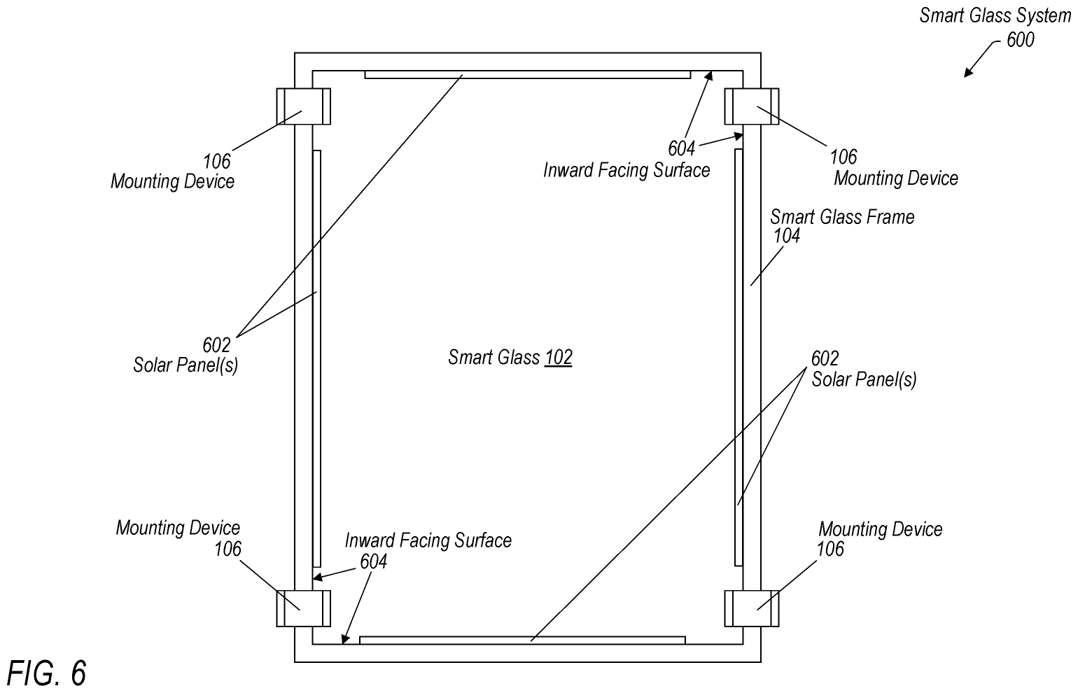

FIG. 6 illustrates a perspective view of an example smart glass system 600 having one or more solar panels according to some aspects of this disclosure. The smart glass system 600 may include one or more same or similar features as the features described with respect to or illustrated in FIGS. 1, 2, 3A, 3B, 4A, 4B, 5, 7, 8, 9, 10, 11, 12, 13, 14, 15, 16, 17A, 17B, 18A, 18B, 19, 20A, 20B, 21, 22, and 23. For example, the smart glass system 600 may include one or more same or similar features as the smart glass system 100 described and illustrated herein. FIG. 6, as with the other included figures, is shown for illustrative purposes and does not limit either the possible embodiments of the present invention or the claims. As described herein, a smart glass system may include one or more power receiving devices. In some aspects, power receiving devices may include solar panels. As shown in FIG. 6, the smart glass system 600 may include a smart glass 102, a smart glass frame 104, one or more mounting devices 106, and a plurality of solar panels 602. The solar panels 602 may be positioned on inward facing surfaces 604 of the smart glass frame 104. In some aspects, the solar panels 602 may have one or more surfaces that extend upward or outward from the inward facing surfaces 604 to better receive sunlight during operation. For example, a solar panel positioned on a bottom inward facing surface 604 may be facing upward to receive sun when the sun is located high in the sky. As another example, a solar panel positioned on a top inward facing surface 604 may be facing outward from the smart glass 102 to receive sun when the sun is located low in the sky. As yet another example, solar panels positions on the left and right inward facing surfaces 604 may be positioned at various angles to receive an optimal amount of sun light.

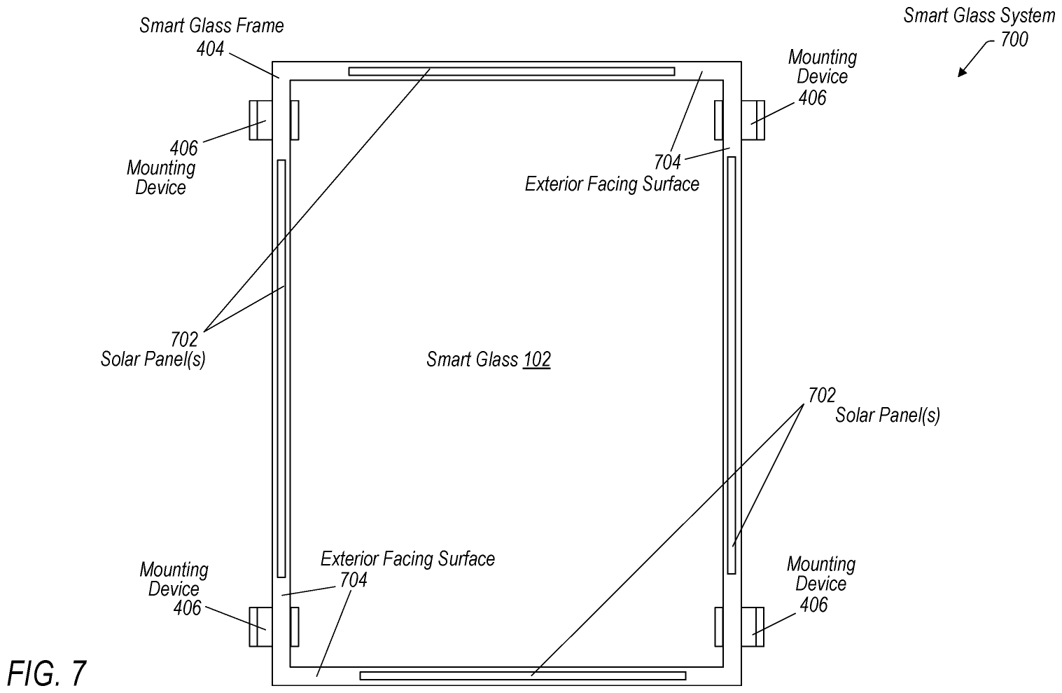

FIG. 7 illustrates another perspective view of an example smart glass system 700 having one or more solar panels according to some aspects of this disclosure. The smart glass system 700 may include one or more same or similar features as the features described with respect to or illustrated in FIGS. 1, 2, 3A, 3B, 4A, 4B, 5, 6, 8, 9, 10, 11, 12, 13, 14, 15, 16, 17A, 17B, 18A, 18B, 19, 20A, 20B, 21, 22, and 23. For example, the smart glass system 700 may include one or more same or similar features as the smart glass system 100 and/or the smart glass system 401 described and illustrated herein. FIG. 7, as with the other included figures, is shown for illustrative purposes and does not limit either the possible embodiments of the present invention or the claims. As described herein, a smart glass system may include one or more power receiving devices. In some aspects, power receiving devices may include solar panels. As shown in FIG. 7, the smart glass system 700 may include a smart glass 102, the smart glass frame 404, the one or more mounting devices 406, and a plurality of solar panels 702. The solar panels 702 may be positioned on exterior facing surfaces 704 of the smart glass frame 404. In some aspects, the solar panels 702 may have one or more surfaces that extend upward or outward from the exterior facing surfaces 704 to better receive sunlight during operation. For example, a solar panel positioned on a bottom exterior facing surface 704 may be facing upward to receive sun when the sun is located high in the sky. As another example, a solar panel positioned on a top exterior facing surface 704 may be facing outward from the smart glass 102 to receive sun when the sun is located low in the sky. As yet another example, solar panels positions on the left and right exterior facing surfaces 704 may be positioned at various angles to receive an optimal amount of sun light.

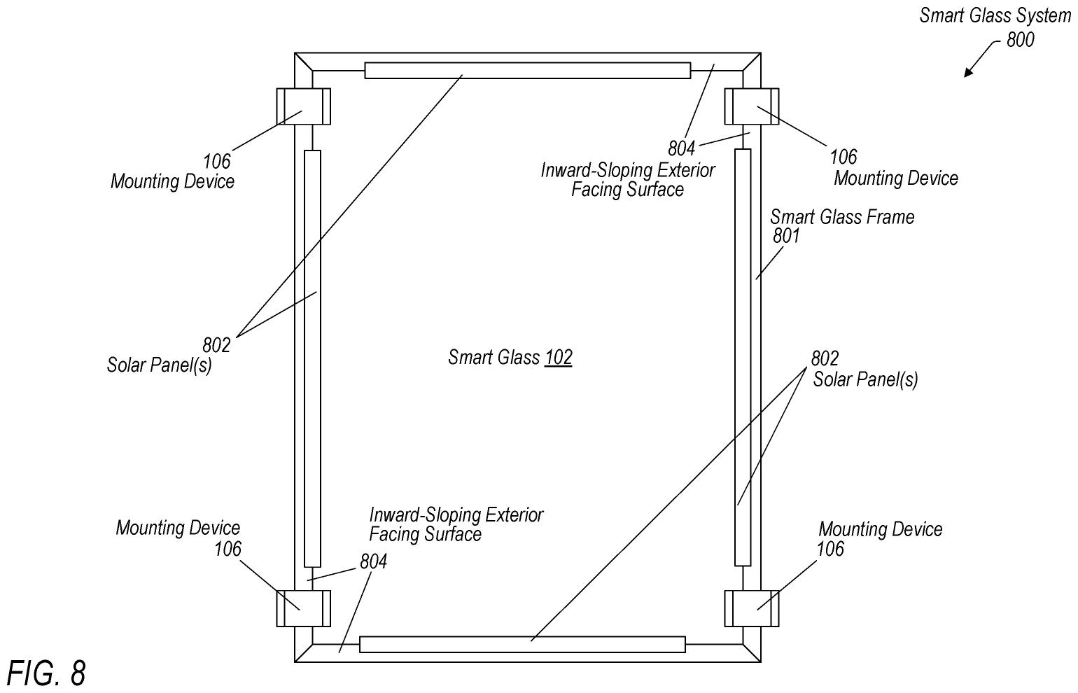

FIG. 8 illustrates another perspective view of an example smart glass system 800 having one or more solar panels according to some aspects of this disclosure. The smart glass system 800 may include one or more same or similar features as the features described with respect to or illustrated in FIGS. 1, 2, 3A, 3B, 4A, 4B, 5, 6, 7, 9, 10, 11, 12, 13, 14, 15, 16, 17A, 17B, 18A, 18B, 19, 20A, 20B, 21, 22, and 23. For example, the smart glass system 800 may include one or more same or similar features as the smart glass system 100, the smart glass system 401, and/or the smart glass system 700 described and illustrated herein. FIG. 8, as with the other included figures, is shown for illustrative purposes and does not limit either the possible embodiments of the present invention or the claims. As described herein, a smart glass system may include one or more power receiving devices. In some aspects, power receiving devices may include solar panels. As shown in FIG. 8, the smart glass system 800 may include a smart glass 102, a smart glass frame 801, one or more mounting devices 106, and a plurality of solar panels 802. The smart glass frame 801 may having inward-sloping exterior facing surfaces 804. The solar panels 802 may be positioned on the inward-sloping exterior facing surfaces 804 of the smart glass frame 801. In some aspects, the solar panels 802 may have one or more surfaces that extend upward or outward from the inward-sloping exterior facing surface 804 to better receive sunlight during operation. For example, a solar panel positioned on a bottom inward-sloping exterior facing surface 804 may be facing upward to receive sun when the sun is located high in the sky. As another example, a solar panel positioned on a top inward-sloping exterior facing surface 804 may be facing outward from the smart glass 102 to receive sun when the sun is located low in the sky. As yet another example, solar panels positions on the left and right inward-sloping exterior facing surfaces 804 may be positioned at various angles to receive an optimal amount of sun light.

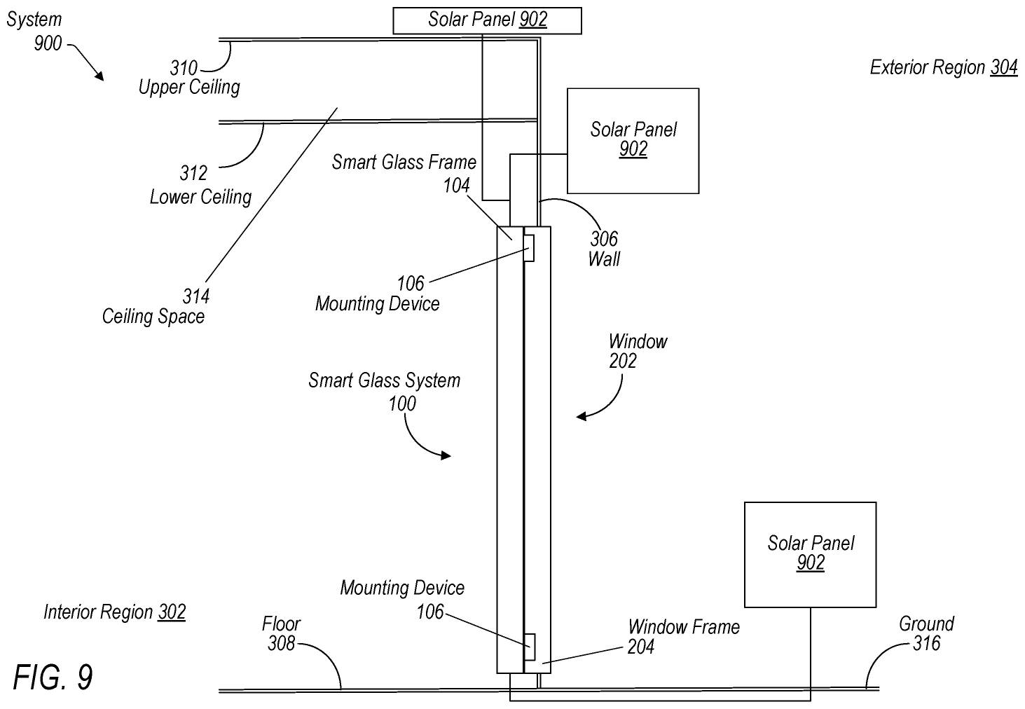

FIG. 9 illustrates a side view of an example system 900 including a smart glass system 100 mounted to a window frame and including one or more solar panels according to some aspects of this disclosure. The system 900 may include one or more same or similar features as the features described with respect to or illustrated in FIGS. 1, 2, 3A, 3B, 4A, 4B, 5, 6, 7, 8, 10, 11, 12, 13, 14, 15, 16, 17A, 17B, 18A, 18B, 19, 20A, 20B, 21, 22, and 23. For example, the system 900 may include one or more same or similar features as the system 300 illustrated in FIGS. 3A and 3B. FIG. 9, as with the other included figures, is shown for illustrative purposes and does not limit either the possible embodiments of the present invention or the claims. As shown in FIG. 9, the window frame 204 containing the window 202 may be retained in a wall 306 separating an interior region 302 from an exterior region 304. The interior region 302 may be the interior of a building. The interior region 302 may include the floor 308, an upper ceiling 310, a lower ceiling 312, and a ceiling space 314 formed by the wall 306, the upper ceiling 310 and the lower ceiling 312. The exterior region 304 may include ground 316 and may include one or more external light sources and particularly the sun. The smart glass system 100 may be attached to the window frame 204 on an interior side of the window frame 204 using the mounting devices 106. As shown in FIG. 9, the smart glass system 100 may include a plurality of solar panels 902. The controller 108 may be positioned within the smart glass system 100 as described herein. Also, the solar panels 902 may be positioned at different positions in or at the exterior region 304 and be in communication with the controller 108 and the smart glass system 100. For example, a solar panel 902 may be positioned above the upper ceiling 310, for example, on a roof. Another solar panel 902 may be positioned on an exterior surface of the wall 306. Yet another solar panel 902 may be positioned at a location on or attached to the ground 316.

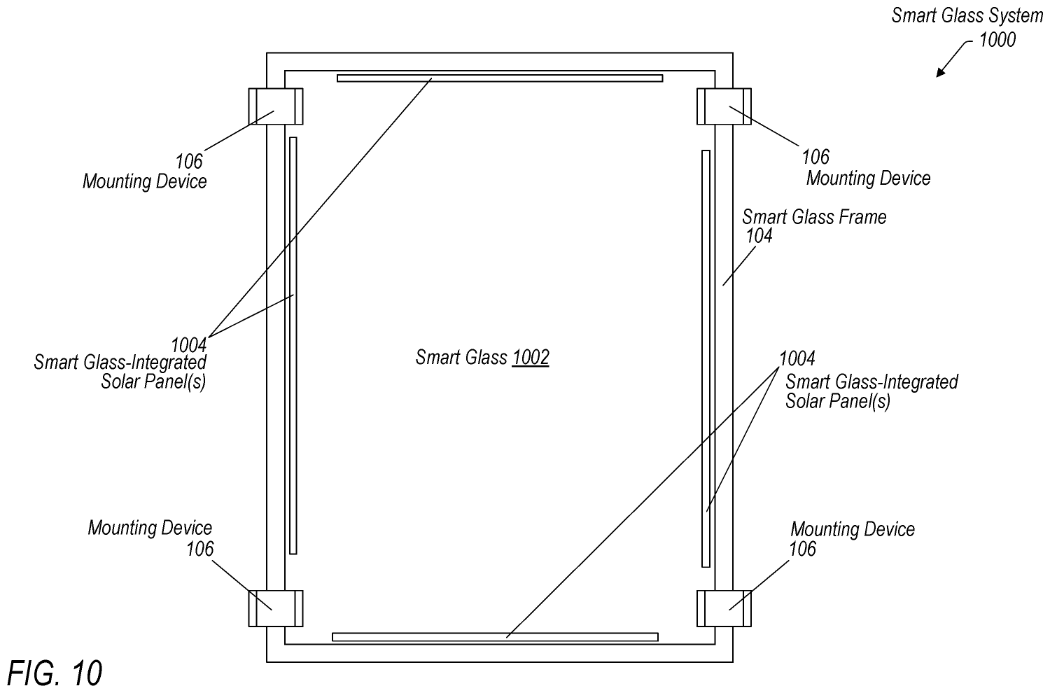

FIG. 10 illustrates another perspective view of an example smart glass system 1000 having one or more smart glass-integrated solar panels according to some aspects of this disclosure. The smart glass system 1000 may include one or more same or similar features as the features described with respect to or illustrated in FIGS. 1, 2, 3A, 3B, 4A, 4B, 5, 6, 7, 8, 9, 11, 12, 13, 14, 15, 16, 17A, 17B, 18A, 18B, 19, 20A, 20B, 21, 22, and 23. For example, the smart glass system 1000 may include one or more same or similar features as the smart glass system 100, the smart glass system 401, the smart glass system 700, and/or the smart glass system 800 described and illustrated herein. FIG. 10, as with the other included figures, is shown for illustrative purposes and does not limit either the possible embodiments of the present invention or the claims. As described herein, a smart glass system may include one or more power receiving devices. In some aspects, power receiving devices may include solar panels. As shown in FIG. 10, the smart glass system 1000 may include a smart glass 1002, a smart glass frame 104, one or more mounting devices 106, and a plurality of solar panels 1004. The solar panels 1004 may be transparent or translucent and may be positioned on and/or within the smart glass 1002. For example, the solar panels 1004 may be positioned around an outer perimeter of the smart glass 1002 adjacent the smart glass frame 104. As sunlight contacts the smart glass 1002 and/or penetrates through the smart glass 1002, the solar panels 1004 may receive the sunlight for conversion into electricity to change or maintain a tint of the smart glass 1002.

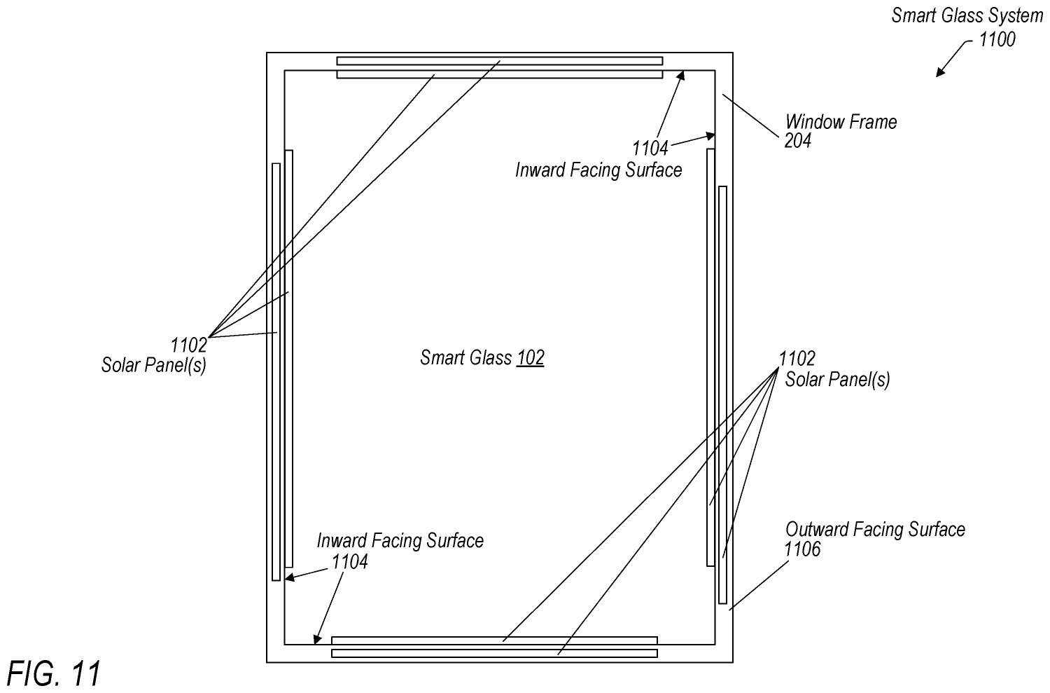

FIG. 11 illustrates a perspective view of an example smart glass system 1100 having one or more solar panels mounted to a window frame 204 according to some aspects of this disclosure. The smart glass system 1100 may include one or more same or similar features as the features described with respect to or illustrated in FIGS. 1, 2, 3A, 3B, 4A, 4B, 5, 6, 7, 8, 9, 10, 12, 13, 14, 15, 16, 17A, 17B, 18A, 18B, 19, 20A, 20B, 21, 22, and 23. For example, the smart glass system 1100 may include one or more same or similar features as the smart glass system 100, the smart glass system 401, the smart glass system 700, the smart glass system 800, and/or the smart glass system 1000 as described and illustrated herein. FIG. 11, as with the other included figures, is shown for illustrative purposes and does not limit either the possible embodiments of the present invention or the claims. As described herein, a smart glass system may include one or more power receiving devices. In some aspects, power receiving devices may include solar panels. As shown in FIG. 11, the smart glass system 1100 may include a plurality of solar panels 1102 mounted on one or more surfaces of a window frame 204. For example, the window frame 204 may have one or more outward facing surfaces 1106, that for example, may be for facing towards or into an exterior region 304. The outward facing surfaces 1106 may retain one or more solar panels 1102 for capturing sunlight and converting the sunlight into electricity for the smart glass 102. As another example, the window frame 204 may have one or more inward facing surfaces 1104 that may face in a direction along a surface of the smart glass 102. The inward facing surfaces 1104 may also retain one or more solar panels 1102 for capturing sunlight and converting the sunlight into electricity for the smart glass 102. The solar panels 1102 may have one or more surfaces that face in various directions or may be moved in various directions as described herein to capture sunlight.

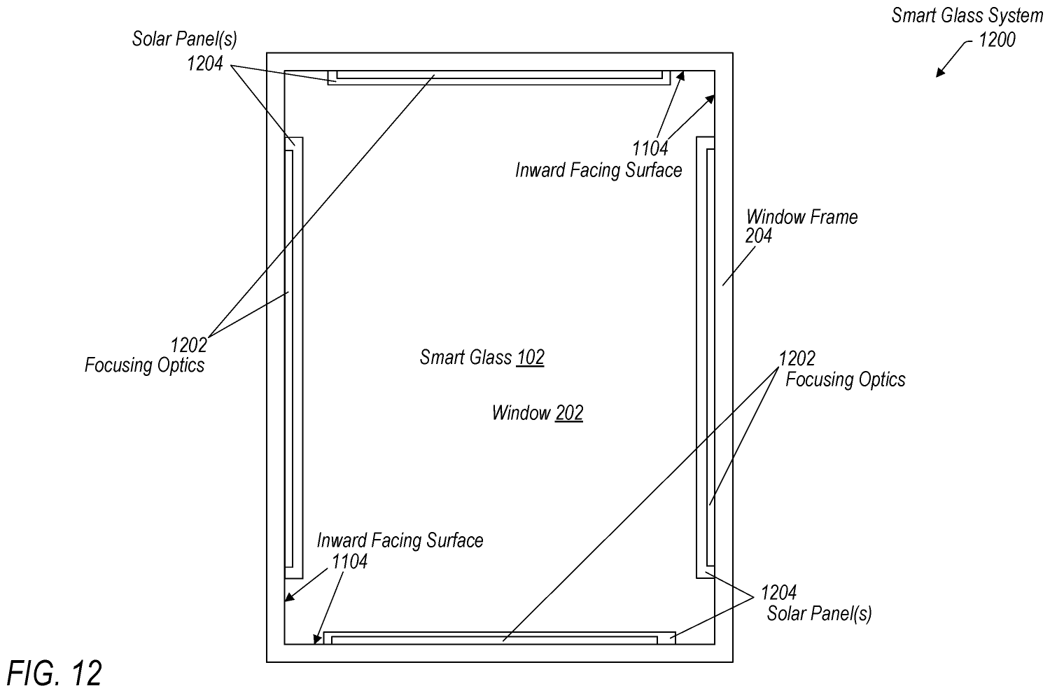

FIG. 12 illustrates a perspective view of an example smart glass system 1200 having one or more focusing optics mounted to a window frame according to some aspects of this disclosure. The smart glass system 1200 may include one or more same or similar features as the features described with respect to or illustrated in FIGS. 1, 2, 3A, 3B, 4A, 4B, 5, 6, 7, 8, 9, 10, 11, 13, 14, 15, 16, 17A, 17B, 18A, 18B, 19, 20A, 20B, 21, 22, and 23. For example, the smart glass system 1200 may include one or more same or similar features as the smart glass system 100, the smart glass system 401, the smart glass system 700, the smart glass system 800, the smart glass system 1000, and/or the smart glass system 1100 as described and illustrated herein. FIG. 12, as with the other included figures, is shown for illustrative purposes and does not limit either the possible embodiments of the present invention or the claims. As described herein, a smart glass system may include one or more power receiving devices. In some aspects, power receiving devices may include solar panels 1204 positioned on a surface of the smart glass frame (e.g., the smart glass frame 104 described herein) located behind the window 202 and the window frame 204. In some cases, one or more reflecting surfaces or focusing optics 1202 may be positioned to reflect light and focus light toward the solar panels 1204 for more efficient sunlight capture. As shown in FIG. 12, the smart glass system 1200 may include a plurality of focusing optics 1202 mounted on one or more surfaces of a window frame 204. For example, the window frame 204 may have one or more inward facing surfaces 1104 that may face in a direction along a surface of the smart glass 102. The inward facing surfaces 1104 may retain one or more focusing optics 1202 for reflecting or focusing light towards the solar panels 1204 for capturing sunlight and converting the sunlight into electricity for the smart glass 102. The focusing optics 1202 may have one or more surfaces that face in various directions or may be moved in various directions as described herein to reflect or focus sunlight for capture by the solar panels 1204.

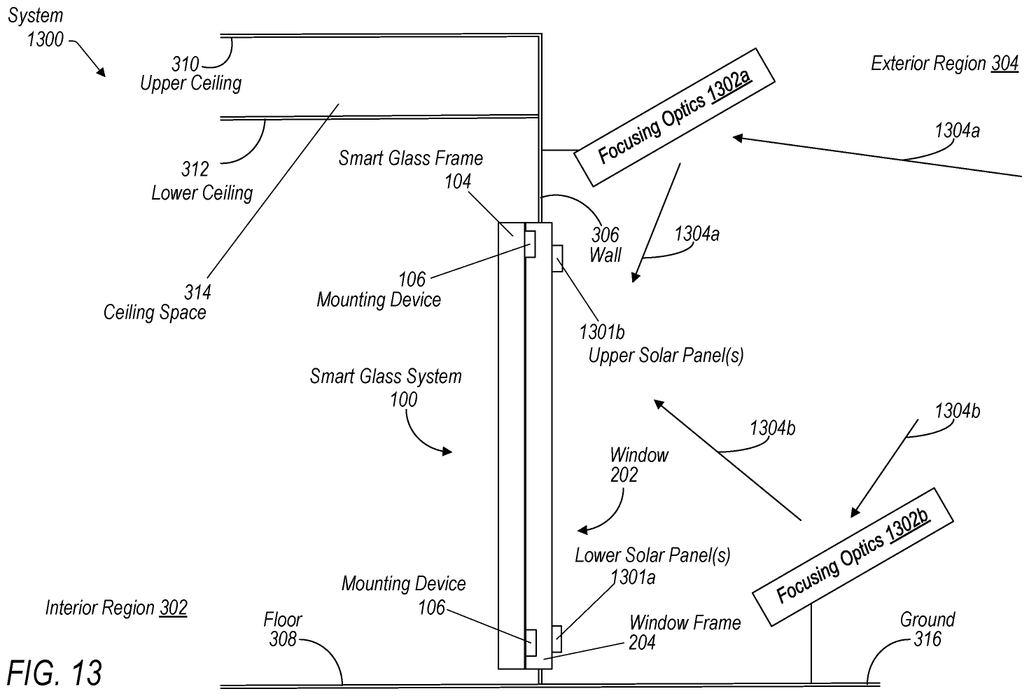

FIG. 13 illustrates a side view of an example system 1300 including a smart glass system 100 mounted to a window frame 204 and including one or more solar panels mounted in an exterior region according to some aspects of this disclosure. The system 1300 may include one or more same or similar features as the features described with respect to or illustrated in FIGS. 1, 2, 3A, 3B, 4A, 4B, 5, 6, 7, 8, 9, 10, 11, 12, 14, 15, 16, 17A, 17B, 18A, 18B, 19, 20A, 20B, 21, 22, and 23. For example, the system 1300 may include one or more same or similar features as the system 300 illustrated in FIGS. 3A and 3B and the system 900 illustrated in FIG. 9. FIG. 13, as with the other included figures, is shown for illustrative purposes and does not limit either the possible embodiments of the present invention or the claims. As shown in FIG. 13, the window frame 204 containing the window 202 may be retained in a wall 306 separating an interior region 302 from an exterior region 304. The interior region 302 may be the interior of a building. The interior region 302 may include the floor 308, an upper ceiling 310, a lower ceiling 312, and a ceiling space 314 formed by the wall 306, the upper ceiling 310 and the lower ceiling 312. The exterior region 304 may include ground 316 and may include one or more external light sources and particularly the sun. The smart glass system 100 may be attached to the window frame 204 on an interior side of the window frame 204 using the mounting devices 106. The smart glass system 100 may include the controller 108 (e.g., located within the smart glass frame 104) and a plurality of solar panels 1301. Also as described herein, the smart glass system 100 may include one or more solar panels 1301 positioned on an exterior surface of the window frame 204 for receiving sunlight and converting the sunlight into electrical power to maintain or change a tint of the smart glass 102. In addition, the smart glass system 100 may include a plurality of focusing optics 1302 including a first focusing optics device 1302a and a second focusing optics device 1302b both mounted in the exterior region 304. The first focusing optics device 1302a may direct and reflect light towards one or more lower solar panels 1301a on the window frame 204 through the first path 1304a. Similarly, the second focusing optics device 1302b may direct and reflect light towards one or more upper solar panels 1301b on the window frame 204 through the second path 1304b.

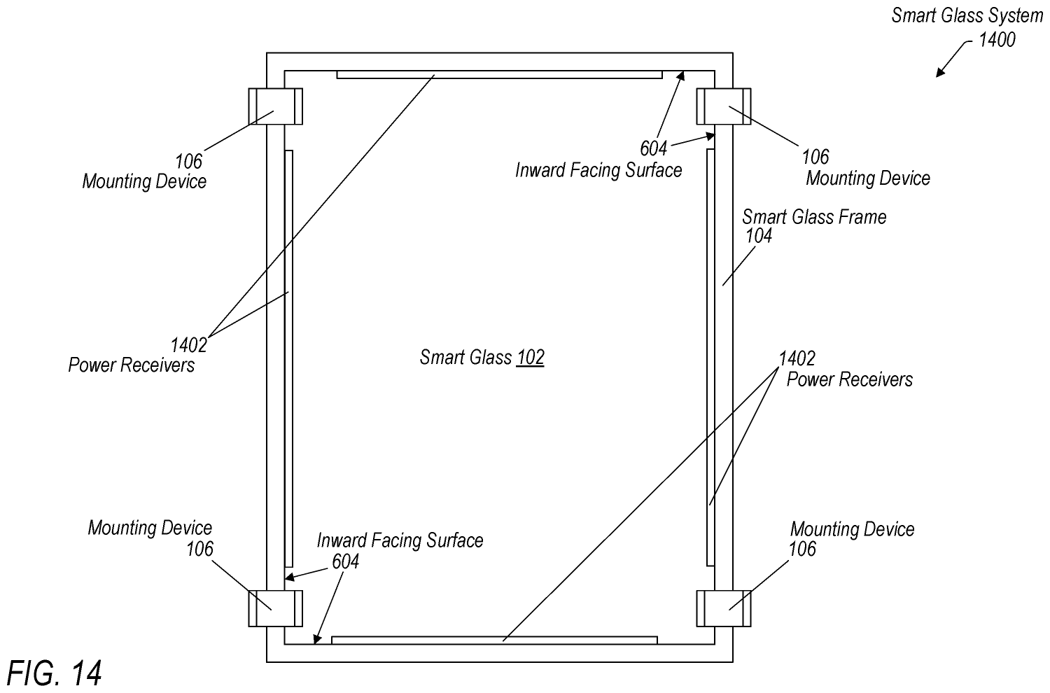

FIG. 14 illustrates a perspective view of an example smart glass system 1400 having one or more power receivers mounted to a smart glass frame according to some aspects of this disclosure. The smart glass system 1400 may include one or more same or similar features as the features described with respect to or illustrated in FIGS. 1, 2, 3A, 3B, 4A, 4B, 5, 6, 7, 8, 9, 10, 11, 12, 13, 15, 16, 17A, 17B, 18A, 18B, 19, 20A, 20B, 21, 22, and 23. For example, the smart glass system 1400 may include one or more same or similar features as the smart glass system 100, the smart glass system 401, the smart glass system 700, the smart glass system 800, the smart glass system 1000, the smart glass system 1100, and/or the smart glass system 1200 as described and illustrated herein. FIG. 14, as with the other included figures, is shown for illustrative purposes and does not limit either the possible embodiments of the present invention or the claims. As described herein, a smart glass system may include one or more power receiving devices. In some aspects, power receiving devices may include one or more wireless power receivers 1402 (e.g., transceivers) for receiving wireless power from one or more wireless power transmitters as described herein. As shown in FIG. 14, the smart glass system 1400 may include a plurality of wireless power receivers 1402 mounted on one or more surfaces of the smart glass frame 104. For example, the smart glass frame 104 may have one or more the inward facing surfaces 604 that may face in a direction along a surface of the smart glass 102. The inward facing surfaces 604 may retain one or more wireless power receivers 1402 for receiving wireless electrical power from one or more transmitters for the smart glass 102.

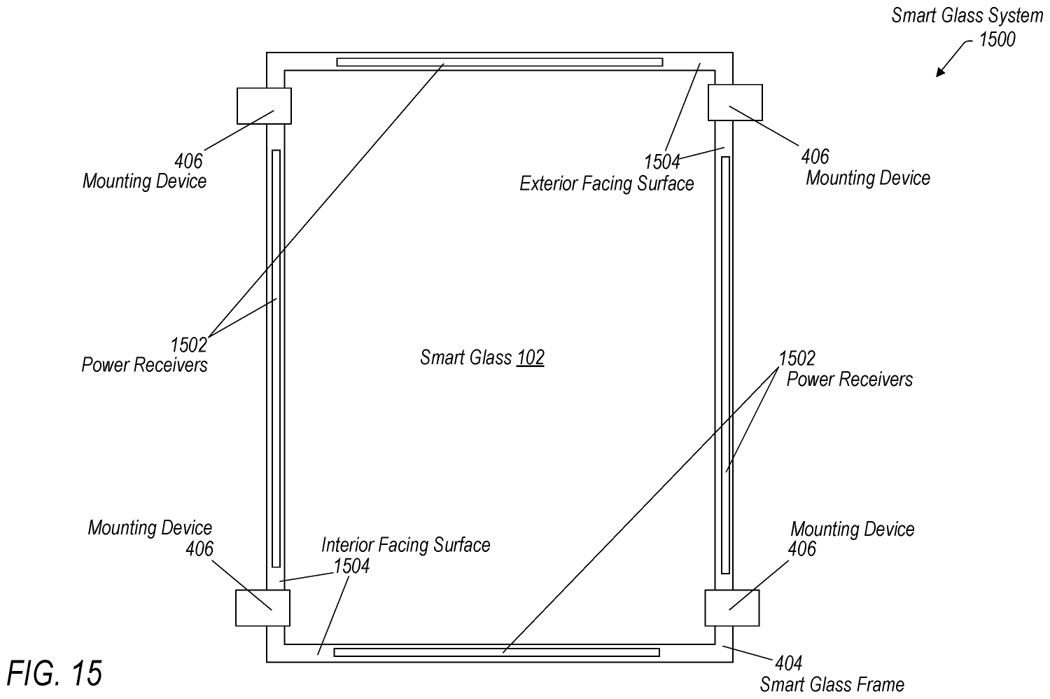

FIG. 15 illustrates a perspective view of another example smart glass system 1500 having one or more power receivers 1502 mounted to a smart glass frame 404 according to some aspects of this disclosure. The smart glass system 1500 may include one or more same or similar features as the features described with respect to or illustrated in FIGS. 1, 2, 3A, 3B, 4A, 4B, 5, 6, 7, 8, 9, 10, 11, 12, 13, 14, 16, 17A, 17B, 18A, 18B, 19, 20A, 20B, 21, 22, and 23. For example, the smart glass system 1500 may include one or more same or similar features as the smart glass system 100, the smart glass system 401, the smart glass system 700, the smart glass system 800, the smart glass system 1000, the smart glass system 1100, the smart glass system 1200, and/or the smart glass system 1400 as described and illustrated herein. FIG. 15, as with the other included figures, is shown for illustrative purposes and does not limit either the possible embodiments of the present invention or the claims. As described herein, a smart glass system may include one or more power receiving devices. In some aspects, power receiving devices may include one or more wireless power receivers 1502 (e.g., transceivers) for receiving wireless power from one or more wireless power transmitters as described herein. As shown in FIG. 15, the smart glass system 1500 may include a plurality of wireless power receivers 1502 mounted on one or more surfaces of the smart glass frame 404. For example, the smart glass frame 404 may have one or more interior facing surfaces 1504 that may face in a direction towards an interior region 302. The interior facing surfaces 1504 may retain one or more wireless power receivers 1502 for receiving wireless electrical power from one or more transmitters for the smart glass 102.

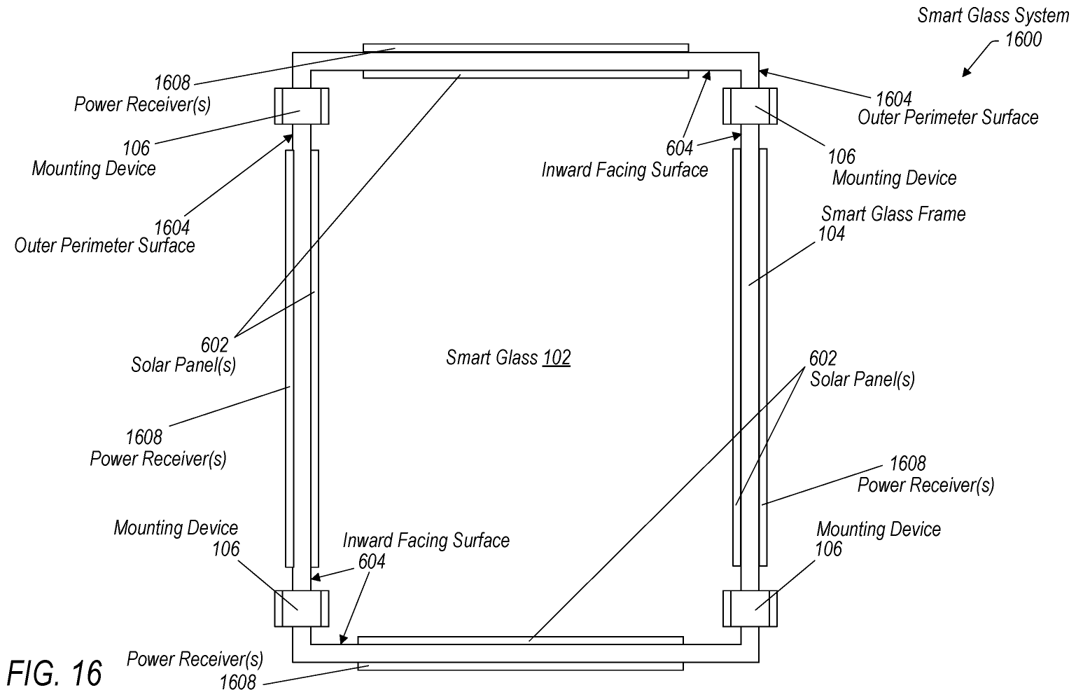

FIG. 16 illustrates a perspective view of an example smart glass system 1600 having one or more solar panels and one or more wireless power receivers mounted to the smart glass frame according to some aspects of this disclosure. The smart glass system 1600 may include one or more same or similar features as the features described with respect to or illustrated in FIGS. 1, 2, 3A, 3B, 4A, 4B, 5, 6, 7, 8, 9, 10, 11, 12, 13, 14, 15, 17A, 17B, 18A, 18B, 19, 20A, 20B, 21, 22, and 23. For example, the smart glass system 1600 may include one or more same or similar features as the smart glass system 100, the smart glass system 401, the smart glass system 700, the smart glass system 800, the smart glass system 1000, the smart glass system 1100, the smart glass system 1200, the smart glass system 1400, and/or the smart glass system 1500 as described and illustrated herein. FIG. 16, as with the other included figures, is shown for illustrative purposes and does not limit either the possible embodiments of the present invention or the claims. As described herein, a smart glass system may include one or more power receiving devices. In some aspects, power receiving devices may include solar panels and wireless power receivers. As shown in FIG. 16, the smart glass system 1600 may include a smart glass 102, a smart glass frame 104, one or more mounting devices 106, a plurality of solar panels 602, and a plurality of wireless power receivers 1604. The solar panels 602 may be positioned on inward facing surfaces 604 of the smart glass frame 104. In some aspects, the solar panels 602 may have one or more surfaces that extend upward or outward from the inward facing surfaces 604 to better receive sunlight during operation. For example, a solar panel positioned on a bottom inward facing surface 604 may be facing upward to receive sun when the sun is located high in the sky. As another example, a solar panel positioned on a top inward facing surface 604 may be facing outward from the smart glass 102 to receive sun when the sun is located low in the sky. As yet another example, solar panels positions on the left and right inward facing surfaces 604 may be orientated at various angles to receive an optimal amount of sun light. The one or more wireless power receivers 1608 (e.g., transceivers) may positioned on outer perimeter surfaces 1604 of the smart glass frame 104 and may receive wireless power from one or more wireless power transmitters as described herein.

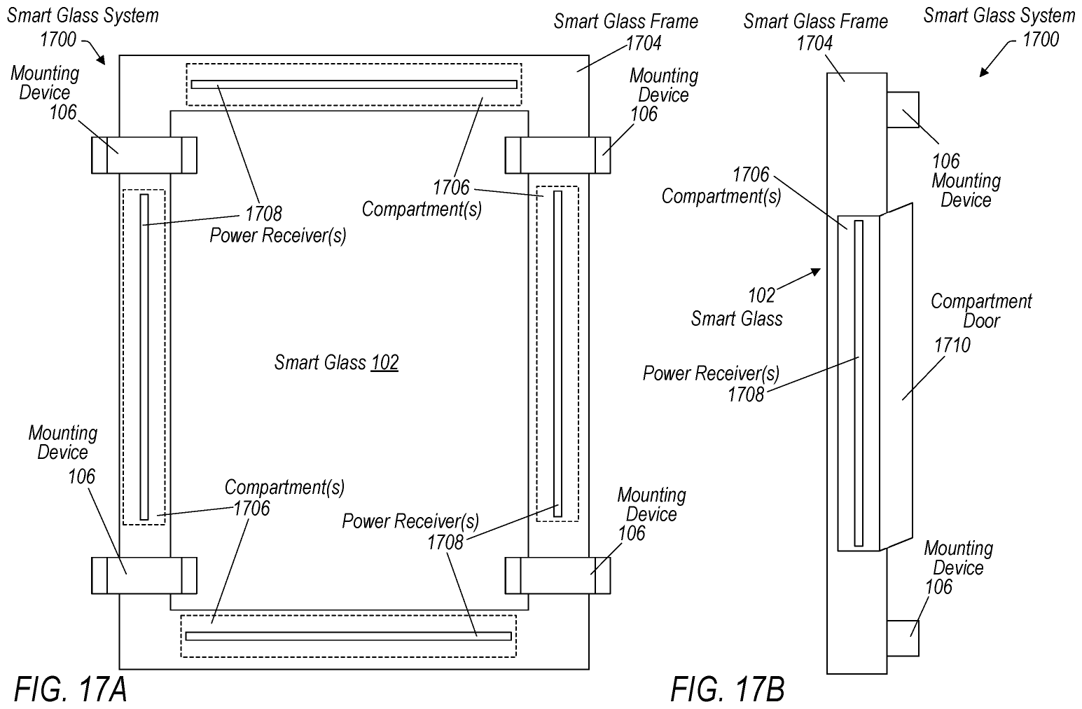

FIG. 17A illustrates a perspective view of an example smart glass system 1700 including a smart glass frame 1704 having one or more compartments 1706 according to some aspects of this disclosure. FIG. 17B illustrates a side view of the example smart glass system 1700 including a smart glass frame 1704 having the one or more compartments 1706 according to some aspects of this disclosure. The smart glass system 1700 may include one or more same or similar features as the features described with respect to or illustrated in FIGS. 1, 2, 3A, 3B, 4A, 4B, 5, 6, 7, 8, 9, 10, 11, 12, 13, 14, 15, 16, 18A, 18B, 19, 20A, 20B, 21, 22, and 23. For example, the smart glass system 1700 may include one or more same or similar features as the smart glass system 100, the smart glass system 401, the smart glass system 700, the smart glass system 800, the smart glass system 1000, the smart glass system 1100, the smart glass system 1200, the smart glass system 1400, and/or the smart glass system 1500 as described and illustrated herein. FIGS. 17A and 17B, as with the other included figures, is shown for illustrative purposes and does not limit either the possible embodiments of the present invention or the claims. As described herein, a smart glass system may include one or more power receiving devices. In some aspects, power receiving devices may include one or more wireless power receivers 1708 (e.g., transceivers) for receiving wireless power from one or more wireless power transmitters as described herein. As shown in FIGS. 17A and 17B, the smart glass system 1700 may include a smart glass frame 1704 having one or more compartments 1706. The one or more compartments 1706 may store electronic equipment within such as wireless power receivers, controllers, power storage devices, and the like. For example, the one or more compartments 1706 may retain a plurality of wireless power receivers 1708 within the smart glass frame 1704 for receiving wireless electrical power from one or more transmitters for the smart glass 102. In some aspects, the smart glass frame 1704 may include a compartment door 1710 for accessing the compartment 1706. The compartment door 1710 may be opened and closed to add and/or replace electronic components within the compartment 1706.

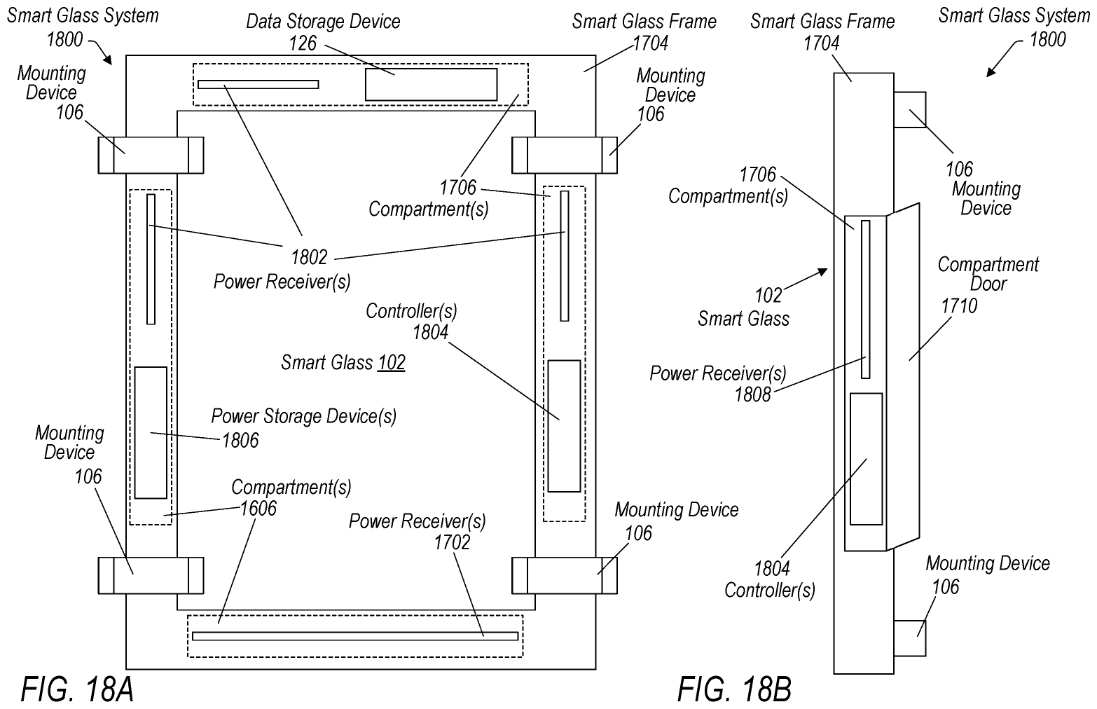

FIG. 18A illustrates a perspective view of an example smart glass system 1800 including a smart glass frame 1704 having one or more compartments 1706 according to some aspects of this disclosure. FIG. 18B illustrates a side view of the example smart glass system 1800 including the smart glass frame 1704 having one or more compartments 1706 according to some aspects of this disclosure. The smart glass system 1800 may include one or more same or similar features as the features described with respect to or illustrated in FIGS. 1, 2, 3A, 3B, 4A, 4B, 5, 6, 7, 8, 9, 10, 11, 12, 13, 14, 15, 16, 17A, 17B, 19, 20A, 20B, 21, 22, and 23. For example, the smart glass system 1800 may include one or more same or similar features as the smart glass system 100, the smart glass system 401, the smart glass system 700, the smart glass system 800, the smart glass system 1000, the smart glass system 1100, the smart glass system 1200, the smart glass system 1400, the smart glass system 1500, and/or the smart glass system 1700 as described and illustrated herein. FIGS. 18A and 18B, as with the other included figures, is shown for illustrative purposes and does not limit either the possible embodiments of the present invention or the claims. As described herein, a smart glass system may include one or more power receiving devices. In some aspects, power receiving devices may include one or more wireless power receivers 1802 (e.g., transceivers) for receiving wireless power from one or more wireless power transmitters as described herein. As shown in FIGS. 18A and 18B, the smart glass system 1800 may include a smart glass frame 1704 having one or more compartments 1706. The one or more compartments 1706 may store electronic equipment within such as wireless power receivers, controllers, power storage devices, data storage devices, and the like. For example, the one or more compartments 1706 may retain a plurality of wireless power receivers 1802, one or more controllers 1804, one or more power storage device 1806, and one or more data storage device 126 within the smart glass frame 1704. The one or more controllers 1808 may be the same as or at least similar to the controller 108 illustrated and described herein. In some aspects, the smart glass frame 1704 may include a compartment door 1710 for accessing the compartment 1706. The compartment door 1710 may be opened and closed to add and/or replace electronic components within the compartment 1706.

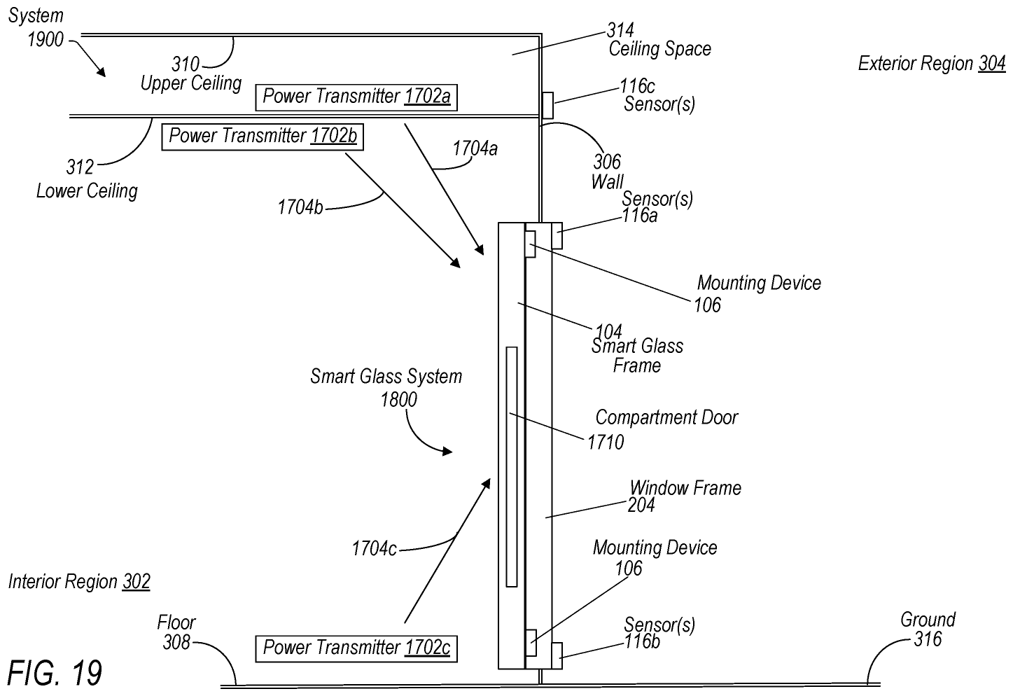

FIG. 19 illustrates a side view of an example system 1900 including a smart glass system 1800 mounted to a window frame 204 and including one or more power transmitters 1702a, 1702b, 1702c for providing wireless power to one or more power receivers of the smart glass system 1800 according to some aspects of this disclosure. The system 1900 may include one or more same or similar features as the features described with respect to or illustrated in FIGS. 1, 2, 3A, 3B, 4A, 4B, 5, 6, 7, 8, 9, 10, 11, 12, 13, 14, 15, 16, 17A, 17B, 18A, 18B, 20A, 20B, 21, 22, and 23. For example, the system 1900 may include one or more same or similar features as the system 300 illustrated in FIGS. 3A and 3B, the system 900 illustrated in FIG. 9, the system 1300 illustrated in FIG. 13, and/or the system 1600 illustrated in FIG. 16. FIG. 19, as with the other included figures, is shown for illustrative purposes and does not limit either the possible embodiments of the present invention or the claims. As shown in FIG. 19, the window frame 204 containing the window 202 may be retained in a wall 306 separating an interior region 302 from an exterior region 304. The interior region 302 may be the interior of a building. The interior region 302 may include the floor 308, an upper ceiling 310, a lower ceiling 312, and a ceiling space 314 formed by the wall 306, the upper ceiling 310 and the lower ceiling 312. The exterior region 304 may include ground 316 and may include one or more external light sources and particularly the sun. The smart glass system 1800 may be attached to the window frame 204 on an interior side of the window frame 204 using the mounting devices 106. The smart glass system 1800 may include the controller 108 and a plurality of wireless receiving devices. The controller 108 may be positioned within the compartment 1706 described herein. Also as described herein, the smart glass system 1800 may include one or more wireless receiving devices stored within the compartment(s) 1706 for providing electrical power to maintain or change a tint of the smart glass 102. In addition, the smart glass system 1800 may include a plurality of wireless power transmitters 1702 including a first wireless power transmitter 1702a, a second wireless power transmitter 1702b, and a third wireless power transmitter 1702c mounted in the interior region 304. The wireless power transmitters may be part of a supervisor system or a building automation system (BAS). The first wireless power transmitter 1702a, located within the ceiling space 314, may transmit power to the one or more wireless power receivers through the first path 1704a. The second wireless power transmitter 1702b, located just below the lower ceiling 312, may transmit power to the one or more wireless power receivers through the second path 1704b. The third wireless power transmitter 1702c, located adjacent the floor 308, may transmit power to the one or more wireless power receivers through the third path 1704c. The wireless power transmitters 1702 may be positioned relatively close to the smart glass system 1800 to transmit wireless power to the wireless power receivers. In addition, the wireless power transmitters 1702 and the wireless power receivers may be transceivers for transmitting data between the smart glass system 1800 and the supervisor system and/or the BAS via the wireless power transmitters 1702. Thus, the individual smart glass system 1800 may individually control a tint of the smart glass as well as the supervisor system and/or the BAS through the wireless power transmitters 1702 may control a tint of the smart glass.

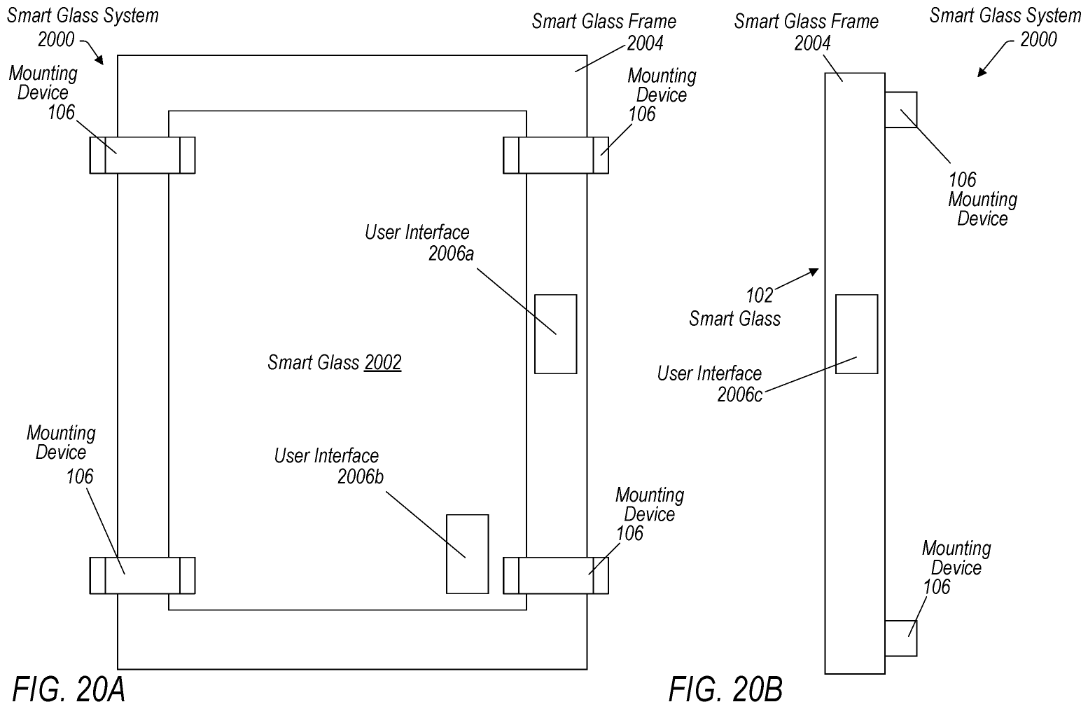

FIG. 20A illustrates a perspective view of an example smart glass system 2000 having one or more user interfaces 2006a, 2006b, 2006c according to some aspects of this disclosure. FIG. 20B illustrates a side view of the example smart glass system 2000 having one or more user interfaces 2006a, 2006b, 2006c according to some aspects of this disclosure. The system 2000 may include one or more same or similar features as the features described with respect to or illustrated in FIGS. 1, 2, 3A, 3B, 4A, 4B, 5, 6, 7, 8, 9, 10, 11, 12, 13, 14, 15, 16, 17A, 17B, 18A, 18B, 19, 21, 22, and 23. For example, the smart glass system 2000 may include one or more same or similar features as the smart glass system 100, the smart glass system 401, the smart glass system 700, the smart glass system 800, the smart glass system 1000, the smart glass system 1100, the smart glass system 1200, the smart glass system 1400, the smart glass system 1500, the smart glass system 1700, and/or the smart glass system 1800 as described and illustrated herein. FIGS. 20A and 20B, as with the other included figures, is shown for illustrative purposes and does not limit either the possible embodiments of the present invention or the claims. As described herein, a smart glass system may one or more user interfaces 2006 for a user to input parameters, change parameters, and/or adjust performance and power settings of the smart glass system. For example, a user interface 2006 may allow a user to provide the smart glass system 2000 with one or more parameters to set or change a tint level of the smart glass, set or change a tint timing of the smart glass, set or change a rate of change for tinting the smart glass, and/or the like. One or more user interfaces may be positioned at one or more different locations with respect to the smart glass system 2000. As shown in FIG. 20A, a user interface 2006a may be positioned on a front surface of the smart glass frame 2004. In some aspects, a user interface 2006b may be embedded within the smart glass itself using a touch screen display. As shown in FIG. 20B, a user interface 2006c may be positioned on a side surface of the smart glass frame 2004.

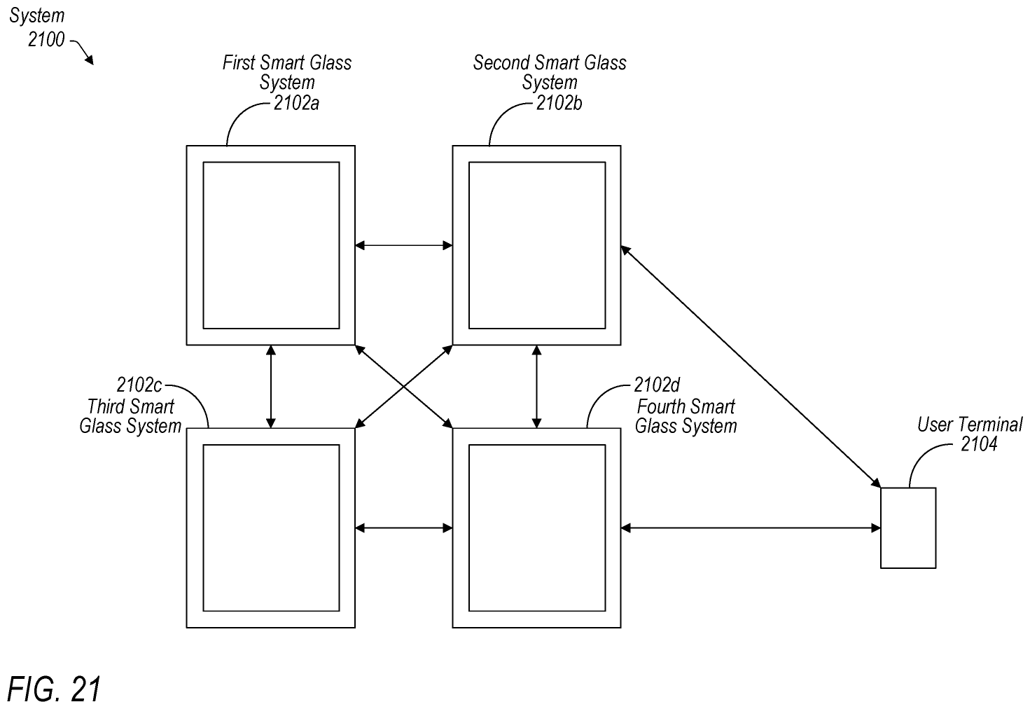

FIG. 21 illustrates a perspective view of an example system 2100 including a plurality of smart glass systems 2102a, 2102b, 2102c, and 2102d in electronic communication with a user terminal 2104 according to some aspects of this disclosure. The system 2100 may include one or more same or similar features as the features described with respect to or illustrated in FIGS. 1, 2, 3A, 3B, 4A, 4B, 5, 6, 7, 8, 9, 10, 11, 12, 13, 14, 15, 16, 17A, 17B, 18A, 18B, 19, 20A, 20B, 22, and 23. For example, the system 2100 may include one or more same or similar features as the system 300 illustrated in FIGS. 3A and 3B, the system 900 illustrated in FIG. 9, the system 1300 illustrated in FIG. 13, the system 1600 illustrated in FIG. 16, and/or the system 1900 illustrated in FIG. 19. FIG. 21, as with the other included figures, is shown for illustrative purposes and does not limit either the possible embodiments of the present invention or the claims. As shown in FIG. 21, the system 2100 may include a plurality of smart glass system 2102. For example, the system 2100 may include a first smart glass system 2102a, a second smart glass system 2102b, a third smart glass system 2102c, and a fourth smart glass system 2102d. Each of the first smart glass system 2102a, the second smart glass system 2102b, the third smart glass system 2102c, and the fourth smart glass system 2102d may be the same as or at least similar to the smart glass system 100 illustrated in FIG. 1, the smart glass system 401, the smart glass system 700, the smart glass system 800, the smart glass system 1000, the smart glass system 1100, the smart glass system 1200, the smart glass system 1400, the smart glass system 1500, the smart glass system 1700, and/or the smart glass system 1800 as described and illustrated herein.

In some aspects, as described herein, smart glass systems may include one or more wireless power receivers (e.g., one or more wireless receivers, one or more wireless transceivers). The wireless power receiver(s) may be positioned on a surface of the smart glass frame, in a compartment within the smart glass frame 104, and/or positioned at a location near the smart glass system (e.g., on a building wall near the smart glass system, on a ceiling near the smart glass system, on a floor near the smart glass system, or beneath a floor near a smart glass system). The one or more power receiver(s) may receive wireless power from one or more wireless transmitters (e.g., wireless transceiver(s)) positioned near the smart glass system (e.g., within an interior region/area of a building, in an exterior region/area outside a building). For example, the one or more wireless transmitters may be positioned at a central or suitable location (e.g., having wireless transmission path(s) or direction(s) to the smart glass systems that are minimally obstructed) near and/or amongst a plurality of smart glass systems to distribute wireless power to the wireless power receiver(s) of the respective smart glass systems. Further, reflective surfaces may be used to re-focus the wirelessly transferred energy from the wireless transmitter to the wireless receiver(s) to improve efficiency without increasing antenna size. In some aspects, if the wireless transmitter provided wireless power to the smart glass system via the wireless receiver(s) is powered by low-voltage direct current (DC), power sources may be easily added or changed without requiring a high-voltage electrician for the installation or move.

When the power receiving devices (e.g., the power receiving device 110, illustrated in at least FIG. 1) including wireless transceivers, the controller(s) (e.g., the controller(s) 108, illustrated in at least FIG. 1) of the respective smart glass systems may utilize the wireless transceiver to communicate data with one or more other smart glass systems, a building automation system (BAS), and/or a user interface (UI) on a user terminal. For example, the first smart glass system 2102a, the second smart glass system 2102b, the third smart glass system 2102c, and the fourth smart glass system 2102d may utilize wireless transceivers to communicate with one another via a first wireless network (e.g., a wireless local area network (WLAN), a BAS via a second wireless network (e.g., another WLAN), and/or a UI on a user terminal 2104 via a third wireless network (e.g., near-field communication). The first network may include communication pathways as depicted in FIG. 21 with the bi-directional arrowed-lines between smart glass systems. In some aspects, the wireless power receivers (e.g., transceivers), may be used as occupancy sensors to directly determine that a path to one or more windows has been interrupted. This information may be used to control (e.g., change or maintain a tint) of the respective smart glass of the respective smart glass systems. For example, the first smart glass system 2102a, the second smart glass system 2102b, the third smart glass system 2102c, and the fourth smart glass system 2102d may communicate with each other, a BAS via the transmitter, a supervisor system via the transmitter, and/or the user terminal 2104 to communicate a current and/or a scheduled (e.g., commanded) tinting level of a respective smart glass, one or more sensed parameters sensed by one or more sensor 116, an amount of power received from one or more solar panels, an amount of power stored in a power storage device, an amount of power received by one or more wireless power receives and/or one or more wired power sources, and/or the like. This data may be used to operate the first smart glass system 2102a, the second smart glass system 2102b, the third smart glass system 2102c, and the fourth smart glass system 2102d according to predetermined and/or scheduled settings of the respective smart glass and well as charge power storage devices of respective smart glass systems.

In some aspects, communication between the smart glass system may allow for anticipating when a smart glass system may need additional power to change a tint. For example, the first smart glass system 2102a may be next to the second smart glass system 2102b. The first smart glass system 2102a and the second smart glass system 2102b may be aware of each other relative positions such that when the first smart glass system 2102a receives sunlight, both the first smart glass system 2102a and the second smart glass 2101b may know that the second smart glass system 2102b will receive sunlight at a particular time after the first smart glass system 2102a receives sunlight. Thus, when the first smart glass system 2101a receives sunlight, the first smart glass system 2101a may inform the second smart glass system 2101b that the first smart glass system 2101a has received sunlight and that the second smart glass system 2101b is prepared for receiving energy to change a tint of the smart glass when the second smart glass system 2101b receives sunlight.

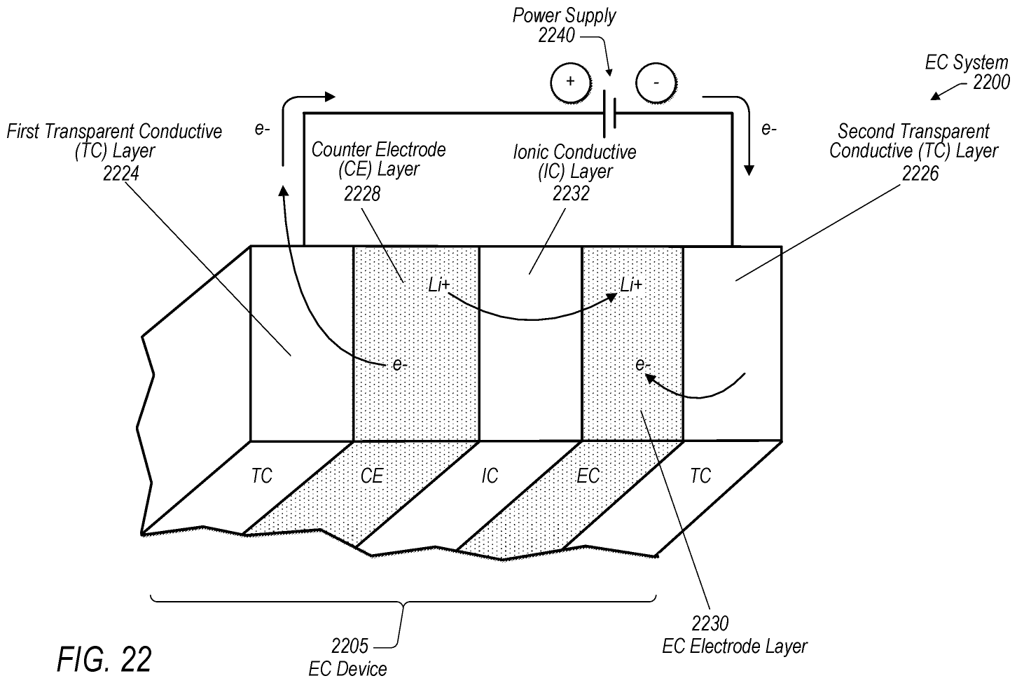

FIG. 22 illustrates a perspective view of an example EC system 2200 according to some aspects of this disclosure. The EC system 2200 may include one or more same or similar features as the features described with respect to or illustrated in FIGS. 1, 2, 3A, 3B, 4A, 4B, 5, 6, 7, 8, 9, 10, 11, 12, 13, 14, 15, 16, 17A, 17B, 18A, 18B, 19, 20A, 20B, 21, and 23. FIG. 22, as with the other included figures, is shown for illustrative purposes and does not limit either the possible embodiments of the present invention or the claims. In this example, the EC system 2200 may include an EC device 2205 for being secured to or positioned against a substrate. The substrate may include one or more optically transparent materials, e.g., glass, plastic, and the like (e.g., a window 202). For instance, the EC device 2205 may include a thin film which may be deposited on to the substrate. The EC device 2205 may include a first transparent conductive (TC) layer 2224 and a second TC layer 2226 for contacting the substrate. In some aspects, the first TC layer 2224 and the second TC layer 2226 may be, or may include, one or more transparent conductive oxide (TCO) layers. The EC device 2205 may also include a counter electrode (CE) layer 2228 in contact with the first TC layer 2224, an EC electrode layer 2230 in contact with the second TC layer 2226, and ionic conductor (IC) layer 2232 in-between (e.g., “sandwiched” between) the CE layer 2228 and the EC electrode layer 2230. The EC system 2200 may include a power supply 2240 (e.g., a power storage device 112, one or more power receiving devices 110, a wired power source 114) which may provide regulated current or voltage to the EC device 2205. Transparency of the EC device 2205 may be controlled by regulating density of charges (or lithium ions) in the CE layer 2228 and/or the EC electrode layer 2230 of the EC device 2205. For instance, when the EC system 2200 applies a positive voltage from the power supply 2240 to the first TC layer 2224, lithium ions may be driven across the IC layer 2232 and inserted into the EC electrode layer 2230. Simultaneously, charge-compensating electrons may be extracted from the CE layer 2228, may flow across the external circuit, and may flow into the EC electrode layer 2230. Transfer of lithium ions and associated electrons from the CE layer 2228 to the EC electrode layer 2230 may cause the EC device 2205 to become darker—e.g., the visible light transmission of the EC device 2205 may decrease. Reversing the voltage polarity may cause the lithium ions and associated charges to return to their original layer, the CE layer 2228, and as a result, the EC device 2205 may return to a clear state—e.g., the visible light transmission of the EC device 2205 may increase.

As described herein, a device such as the EC device 2205 of FIG. 22 may include one or more sections extending at least partially therethrough to enhance electromagnetic communication of one or more electromagnetic communication bands through the device and, thus, through the coated transparent substrate while maintaining a minimum amount of tinting or shading through the coated transparent substrate.

In some aspects, a smart glass system for mounting on a glass frame is provided. The smart glass system includes a smart glass frame. The smart glass system also includes a smart glass retained by the smart glass frame. The smart glass system further includes one or more mounting devices attached to the smart glass frame for mounting the smart glass frame and the smart glass to the glass frame. In addition, the smart glass system includes a plurality of power receiving devices in electronic communication with the smart glass for receiving wireless power for the smart glass. The plurality of power receiving devices include one or more solar panels and one or more wireless power receivers. The smart glass system also includes one or more power storage devices for storing power for the smart glass. The smart glass system further includes a controller for managing power flow between the plurality of power receiving devices, the one or more power storage devices, and the smart glass. The controller is configured to, when a total amount of power from at least the one or more solar panels and the one or more wireless power receivers is above a threshold amount of power, direct at least some power of the total amount of power to the one or more power storage devices for charging. The controller is also configured to, when the total amount of power from at least the one or more solar panels and the one or more wireless power receivers is not above the threshold amount of power, direct at least some power from the one or more power storage devices to the smart glass for controlling a level of tint of the smart glass.

In some aspects, the controller is configured to, when the total amount of power from at least the one or more solar panels and the one or more wireless power receivers is above the threshold amount of power, direct at least some power of the total amount of power to the smart glass for controlling the level of tint of the smart glass. In some aspects, the controller is configured to, when the total amount of power from at least the one or more solar panels and the one or more wireless power receivers is not above the threshold amount of power, direct the total amount of power to the smart glass for controlling the level of tint of the smart glass. In some aspects, the smart glass frame includes a same size and a same shape as the glass frame, and the smart glass frame is for mounting on an interior facing side of the glass frame. In some aspects, the smart glass frame includes a smaller size than the glass frame and a same shape as the glass frame. In some aspects, the smart glass frame is for mounting on an inward facing side of the glass frame. In some aspects, the smart glass frame is for mounting on a plurality of installed glass frames. In some aspects, the at least one solar panel is mounted on a surface of the smart glass frame. In some aspects, the at least one solar panel is mounted on an inward facing surface of the smart glass frame. In some aspects, the at least one solar panel extends from a respective surface of the smart glass frame at an angle relative to an angle of the respective surface of the smart glass frame. In some aspects, the at least one solar panel faces towards the glass frame. In some aspects, the at least one solar panel is positioned on a perimeter of the glass frame. In some aspects, the at least one solar panel is mounted on a surface that is remote from the smart glass frame. In some aspects, the at least one solar panel is mounted on a surface of the smart glass. In some aspects, the at least one solar panel is shared with another smart glass system. In some aspects, the one or more power receiving devices include at least two solar panels that are electrically wired to the smart glass in series with each other. In some aspects, the smart glass frame includes one or more reflective surfaces for reflecting light towards the at least one solar panel. In some aspects, the smart glass system includes one or more wireless power transmitters configured to transmit wireless power to the at least one wireless power receiver. In some aspects, at least one wireless power transmitter of the one or more wireless power transmitters is positioned at an interior location with respect to the smart glass system. In some aspects, the at least one wireless power transmitter of the one or more wireless transmitters is positioned adjacent to at least one of a ceiling, a wall, or a floor at the interior location with respect to the smart glass system. In some aspects, at least one wireless power transmitter of the one or more wireless power transmitters is positioned at an exterior location with respect to the smart glass system. In some aspects, at least one wireless power transmitter of the one or more wireless power transmitters is in electronic communication with a supervisor system, and the wireless power transmitter and the wireless power receiver are both transceivers configured to facilitate wireless data communication between the controller and the supervisory system. In some aspects, the power storage device is positioned within the smart glass frame. In some aspects, the power storage device is positioned within a field-accessible compartment of the smart glass frame. In some aspects, the smart glass system further includes one or more wired power sources configured to provide power to at least one of the smart glass or the power storage device. In some aspects, the controller is configured to determine an amount of tint for the smart glass, and control the amount of power delivered to the smart glass from the one or more power receiving devices based on the amount of tint determined for the smart glass. In some aspects, the controller is positioned within the smart glass frame. In some aspects, the controller is positioned within a field-accessible compartment of the smart glass frame. In some aspects, the smart glass system further includes one or more sensors, and the controller is configured to receive one or more input parameters from the one or more sensors, determine the amount of tint for the smart glass based on the one or more input parameters, and control the amount of power delivered to the smart glass from one or more power sources including the one or more power receiving devices based on the amount of tint determined for the smart glass. In some aspects, at least one sensor of the one or more sensors is mounted on or within the smart glass frame. In some aspects, the smart glass system further includes a user interface for receiving one or more tint parameters for the smart glass and the controller is configured to determine the amount of tint for the smart glass based on the one or more input parameters and the one or more tint parameters. In some aspects, the user interface is located in at least one of the smart glass or the smart glass frame. In some aspects, the smart glass system further includes a data storage device storing one or more predetermined parameters for the smart glass, and the controller is configured to receive one or more predetermined parameters from the data storage device, determine the amount of tint for the smart glass based on the one or more predetermined parameters, and control the amount of power delivered to the smart glass from the one or more power receiving devices based on the determined amount of tint for the smart glass. In some aspects, the data storage device is positioned within the smart glass frame. In some aspects, the data storage device is positioned within a field-accessible compartment of the smart glass frame. In some aspects, the smart glass system further includes a user interface for receiving one or more tint parameters for the smart glass, and the controller is configured to determine the amount of tint for the smart glass based on the one or more predetermined parameters and the one or more tint parameters. In some aspects, the user interface is located in at least one of the smart glass or the smart glass frame.

In some aspects, a system including a smart glass system for mounting on a glass frame attached to a building is provided. The system includes a smart glass frame. The system also includes a smart glass retained by the smart glass frame. The system further includes one or more mounting device attached to the smart glass frame for mounting the smart glass frame and the smart glass to the glass frame attached to the building. In addition, the system includes a plurality of power receiving devices in electronic communication with the smart glass for receiving wireless power for the smart glass. The plurality of power receiving devices include one or more solar panels and one or more wireless power receivers. The system also includes one or more power storage devices for storing power for the smart glass. The system further includes a controller for managing power flow between the plurality of power receiving devices, the one or more power storage devices, and the smart glass. The controller is configured to, when a total amount of power from at least the one or more solar panels and the one or more wireless power receivers is above a threshold amount of power, direct at least some power of the total amount of power to the one or more power storage devices for charging. The controller is also configured to, when the total amount of power from at least the one or more solar panels and the one or more wireless power receivers is not above the threshold amount of power, direct at least some power from the one or more power storage devices to the smart glass for controlling a level of tint of the smart glass.

In some aspects, an electrochromic insulated glass unit (EC-IGU) system for mounting on a glass frame is provided. The EC-IGU system includes an EC-IGU frame. The EC-IGU system also includes an EC-IGU retained by the EC-IGU frame. The EC-IGU system further includes one or more mounting devices attached to the EC-IGU frame for mounting the EC-IGU frame and the EC-IGU to the glass frame. In addition, the EC-IGU system includes a plurality of power receiving devices in electronic communication with the EC-IGU for receiving wireless power for the EC-IGU. The plurality of power receiving devices includes one or more solar panels and one or more wireless power receivers. The EC-IGU system also includes one or more power storage devices for storing power for the EC-IGU. The EC-IGU system further includes a controller for managing power flow between the plurality of power receiving devices, the one or more power storage devices, and the EC-IGU. The controller is configured to, when a total amount of power from at least the one or more solar panels and the one or more wireless power receivers is above a threshold amount of power, direct at least some power of the total amount of power to the one or more power storage devices for charging. The controller is also configured to, when the total amount of power from at least the one or more solar panels and the one or more wireless power receivers is not above the threshold amount of power, direct at least some power from the one or more power storage devices to the EC-IGU for controlling a level of tint of the EC-IGU.

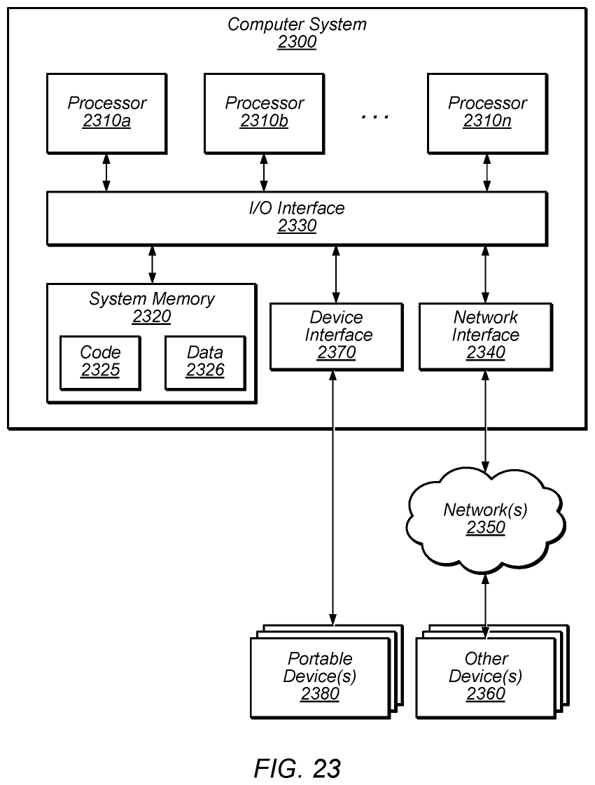

FIG. 23 is a block diagram illustrating a computer system according to various embodiments, as well as various other systems, components, services or devices described above. Computer system 2300 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of computing device. The computer system 2300 may be included with or within one or more components described with respect to or illustrated in FIGS. 1, 2, 3A, 3B, 4A, 4B, 5, 6, 7, 8, 9, 10, 11, 12, 13, 14, 15, 16, 17A, 17B, 18A, 18B, 19, 20A, 20B, 21, and 22. For example, the computer system 2300 may be included with or within any of the controllers, user interfaces, terminal devices, receivers, transmitters, or transceivers, systems, supervisor systems, building automation systems, or the like described herein.

Computer system 2300 includes one or more processors 2310 (any of which may include multiple cores, which may be single or multi-threaded) coupled to a system memory 2320 via an input/output (I/O) interface 2330. Computer system 2300 further includes a network interface 2340 coupled to I/O interface 2330. In various embodiments, computer system 2300 may be a uniprocessor system including one processor 2310, or a multiprocessor system including several processors 2310 (e.g., two, four, eight, or another suitable number). Processors 2310 may be any suitable processors capable of executing instructions. For example, in various embodiments, processors 2310 may be general-purpose or embedded processors implementing any of a variety of instruction set architectures (ISAs), such as the x86, PowerPC, SPARC, or MIPS ISAs, or any other suitable ISA. In multiprocessor systems, each of processors 2310 may commonly, but not necessarily, implement the same ISA. The computer system 2300 also includes one or more network communication devices (e.g., network interface 2340) for communicating with other systems and/or components over a communications network (e.g. Internet, LAN, etc.).

In the illustrated embodiment, computer system 2300 is coupled to one or more portable storage devices 2380 via device interface 2370. In various embodiments, portable storage devices 2380 may correspond to disk drives, tape drives, solid state memory, other storage devices, or any other persistent storage device. Computer system 2300 (or a distributed application or operating system operating thereon) may store instructions and/or data in portable storage devices 2380, as desired, and may retrieve the stored instruction and/or data as needed.

Computer system 2300 includes one or more system memories 2320 that can store instructions and data accessible by processor(s) 2310. In various embodiments, system memories 2320 may be implemented using any suitable memory technology, (e.g., one or more of cache, static random access memory (SRAM), DRAM, RDRAM, EDO RAM, DDR 23 RAM, synchronous dynamic RAM (SDRAM), Rambus RAM, EEPROM, non-volatile/Flash-type memory, or any other type of memory). System memory 2320 may contain program instructions 2325 that are executable by processor(s) 2310 to implement the methods and techniques described herein. In various embodiments, program instructions 2325 may be encoded in platform native binary, any interpreted language such as Java™ byte-code, or in any other language such as C/C++ or the like, or in any combination thereof. For example, in the illustrated embodiment, program instructions 2325 include program instructions executable to implement the functionality of a system, local controller, project database, etc., in different embodiments. In some embodiments, program instructions 2325 may implement multiple systems, project databases, and/or other components.

In some embodiments, program instructions 2325 may include instructions executable to implement an operating system (not shown), which may be any of various operating systems, such as UNIX, LINUX, Solaris™, MacOS™, Windows™, etc. Any or all of program instructions 2325 may be provided as a computer program product, or software, which may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 2300 via I/O interface 2330. A non-transitory computer-readable storage medium may also include any volatile or non-volatile media such as RAM (e.g. SDRAM, DDR SDRAM, RDRAM, SRAM, etc.), ROM, etc., that may be included in some embodiments of computer system 2300 as system memory 2320 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 2340.

In some embodiments, system memory 2320 may include data store 2326, which may be implemented as described herein. For example, the information described herein as being stored by the project database may be stored in data store 2326, or in another portion of system memory 2320 on one or more nodes, in other devices 2360.

In one embodiment, I/O interface 2330 may coordinate I/O traffic between processor 2310, system memory 2320 and any peripheral devices in the system, including through network interface 2340 or other peripheral interfaces, such as device interface 2370. In some embodiments, I/O interface 2330 may perform any necessary protocol, timing or other data transformations to convert data signals from one component (e.g., system memory 2320) into a format suitable for use by another component (e.g., processor 2310). In some embodiments, I/O interface 2330 may include support for devices attached through various types of peripheral buses, such as a variant of the Peripheral Component Interconnect (PCI) bus standard or the Universal Serial Bus (USB) standard, for example. In some embodiments, the function of I/O interface 2330 may be split into two or more separate components, such as a north bridge and a south bridge, for example. Also, in some embodiments, some or all of the functionality of I/O interface 2330, such as an interface to system memory 2320, may be incorporated directly into processor 2310.

Network interface 2340 may allow data to be exchanged between computer system 2300 and other devices attached to a network, such as other computer systems 2360. In addition, network interface 2340 may allow communication between computer system 2300 and various I/O devices and/or remote storage devices. Input/output devices may, in some embodiments, include one or more display terminals, keyboards, keypads, touchpads, scanning devices, voice or optical recognition devices, or any other devices suitable for entering or retrieving data by one or more computer systems 2300. Multiple input/output devices may be present in computer system 2300 or may be distributed on various nodes of a distributed system that includes computer system 2300. In some embodiments, similar input/output devices may be separate from computer system 2300 and may interact with one or more nodes of a distributed system that includes computer system 2300 through a wired or wireless connection, such as over network interface 2340. Network interface 2340 may commonly support one or more wireless networking protocols (e.g., Wi-Fi/IEEE 802.11, or another wireless networking standard). However, in various embodiments, network interface 2340 may support communication via any suitable wired or wireless general data networks, such as other types of Ethernet networks, for example. Additionally, network interface 2340 may support communication via telecommunications/telephony networks such as analog voice networks or digital fiber communications networks, via storage area networks such as Fibre Channel SANs, or via any other suitable type of network and/or protocol. In various embodiments, computer system 2300 may include more, fewer, or different components than those illustrated in FIG. 23 (e.g., displays, video cards, audio cards, peripheral devices, other network interfaces such as an ATM interface, an Ethernet interface, a Frame Relay interface, etc.)

The various methods as illustrated in the figures and described herein represent example embodiments of methods. The methods may be implemented manually, in software, in hardware, or in a combination thereof. The order of any method may be changed, and various elements may be added, reordered, combined, omitted, modified, etc.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed is:

1. A smart glass system for mounting on a glass frame, the smart glass system comprising:
a smart glass frame;
a smart glass retained by the smart glass frame;
one or more mounting devices attached to the smart glass frame for mounting the smart glass frame and the smart glass to the glass frame;
a plurality of power receiving devices in electronic communication with the smart glass for receiving wireless power for the smart glass, wherein the plurality of power receiving devices comprises:
one or more solar panels, and
one or more wireless power receivers;
one or more power storage devices for storing power for the smart glass; and
a controller for managing power flow between the plurality of power receiving devices, the one or more power storage devices, and the smart glass, wherein the controller is configured to:
when a total amount of power from at least the one or more solar panels and the one or more wireless power receivers is above a threshold amount of power, direct at least some power of the total amount of power to the one or more power storage devices for charging, and
when the total amount of power from at least the one or more solar panels and the one or more wireless power receivers is not above the threshold amount of power, direct at least some power from the one or more power storage devices to the smart glass for controlling a level of tint of the smart glass.

2. The smart glass system of claim 1, wherein the controller is further configured to:
when the total amount of power from at least the one or more solar panels and the one or more wireless power receivers is above the threshold amount of power, direct at least some power of the total amount of power to the smart glass for controlling the level of tint of the smart glass.

3. The smart glass system of claim 1, wherein the controller is further configured to:
when the total amount of power from at least the one or more solar panels and the one or more wireless power receivers is not above the threshold amount of power, direct the total amount of power to the smart glass for controlling the level of tint of the smart glass.

4. The smart glass system of claim 1, wherein the smart glass frame comprises a same size and a same shape as the glass frame, and wherein the smart glass frame is for mounting on an interior facing side of the glass frame.

5. The smart glass system of claim 1, wherein the smart glass frame comprises a smaller size than the glass frame and a same shape as the glass frame.

6. The smart glass system of claim 5, wherein the smart glass frame is for mounting on an inward facing side of the glass frame.

7. The smart glass system of claim 1, wherein the smart glass frame is for mounting on a plurality of installed glass frames.

8. The smart glass system of claim 1, wherein the at least one solar panel is mounted on a surface of the smart glass frame.

9. The smart glass system of claim 8, wherein the at least one solar panel is mounted on an inward facing surface of the smart glass frame.

10. The smart glass system of claim 8, wherein the at least one solar panel extends from a respective surface of the smart glass frame at an angle relative to an angle of the respective surface of the smart glass frame.

11. The smart glass system of claim 8, wherein the at least one solar panel faces towards the glass frame.

12. The smart glass system of claim 11, wherein the at least one solar panel is positioned on a perimeter of the glass frame.

13. The smart glass system of claim 1, wherein the at least one solar panel is mounted on a surface that is remote from the smart glass frame.

14. The smart glass system of claim 1, wherein the at least one solar panel is mounted on a surface of the smart glass.

15. The smart glass system of claim 1, wherein the at least one solar panel is shared with another smart glass system.

16. The smart glass system of claim 1, wherein the one or more power receiving device comprise at least two solar panels that are electrically wired to the smart glass in series with each other.

17. The smart glass system of claim 1, wherein the smart glass frame comprises one or more reflective surfaces for reflecting light towards the at least one solar panel.

18. The smart glass system of claim 1, wherein the smart glass system further comprises one or more wireless power transmitters configured to transmit wireless power to the at least one wireless power receiver.

19. A system including a smart glass system for mounting on a glass frame attached to a building, the system comprising:
a smart glass frame;
a smart glass retained by the smart glass frame;
one or more mounting device attached to the smart glass frame for mounting the smart glass frame and the smart glass to the glass frame attached to the building;
a plurality of power receiving devices in electronic communication with the smart glass for receiving wireless power for the smart glass, wherein the plurality of power receiving devices comprises:
one or more solar panels, and
one or more wireless power receivers;
one or more power storage devices for storing power for the smart glass; and
a controller for managing power flow between the plurality of power receiving devices, the one or more power storage devices, and the smart glass, wherein the controller is configured to:
when a total amount of power from at least the one or more solar panels and the one or more wireless power receivers is above a threshold amount of power, direct at least some power of the total amount of power to the one or more power storage devices for charging, and
when the total amount of power from at least the one or more solar panels and the one or more wireless power receivers is not above the threshold amount of power, direct at least some power from the one or more power storage devices to the smart glass for controlling a level of tint of the smart glass.

20. An electrochromic insulated glass unit (EC-IGU) system for mounting on a glass frame, the EC-IGU system comprising:
an EC-IGU frame;
an EC-IGU retained by the EC-IGU frame;
one or more mounting devices attached to the EC-IGU frame for mounting the EC-IGU frame and the EC-IGU to the glass frame;
a plurality of power receiving devices in electronic communication with the EC-IGU for receiving wireless power for the EC-IGU, wherein the plurality of power receiving devices comprises:
one or more solar panels, and
one or more wireless power receivers;
one or more power storage devices for storing power for the EC-IGU; and
a controller for managing power flow between the plurality of power receiving devices, the one or more power storage devices, and the EC-IGU, wherein the controller is configured to:
when a total amount of power from at least the one or more solar panels and the one or more wireless power receivers is above a threshold amount of power, direct at least some power of the total amount of power to the one or more power storage devices for charging, and
when the total amount of power from at least the one or more solar panels and the one or more wireless power receivers is not above the threshold amount of power, direct at least some power from the one or more power storage devices to the EC-IGU for controlling a level of tint of the EC-IGU.
